(19) United States
(12) Patent Application Publication
(10) Pub. No.: US 2023/0183919 A1
(43) Pub. Date: Jun. 15, 2023

(54) HYDROPHOBIC AND OMNIPHOBIC PERIODIC MESOPOROUS ORGANOSILICA-BASED COATINGS AND COATING METHODS

(71) Applicant: TIAX LLC, Lexington, MA (US)

(72) Inventors: Lauren M. Ziemba, Lexington, MA (US); William S. Barney, Lexington, MA (US); Kezi Cheng, Lexington, MA (US); Michael J. Jakubowski, Lexington, MA (US); John F. Martin, Lexington, MA (US); Bradford A. Pindzola, Lexington, MA (US); John R. Powell, Lexington, MA (US)

(21) Appl. No.: 17/997,140

(22) PCT Filed: Apr. 29, 2021
(86) PCT No.: PCT/US2021/029876

§ 371 Date: Oct. 26, 2022

Related U.S. Application Data
(60) Provisional application No. 63/017,851, filed on Apr. 30, 2020.

(51) Int. Cl. D06N 3/12; C09D 5/00; C09D 183/14; C08G 77/50; C09D 7/45; C09D 7/65; C09D 7/20; D06N 3/00

(52) U.S. Cl. CPC D06N 3/128; C09D 5/00; C09D 183/14; C08G 77/50; C09D 7/45; C09D 7/65; C09D 7/20; D06N 3/0006; D06N 3/0011; D06N 3/0088; D06N 2209/16; D06N 2205/16; D06N 2203/066; D06N 2201/042

(57) ABSTRACT

Coated articles include a substrate and a periodic mesoporous organosilica layer adhered to a surface of the substrate. The coated articles may further include a secondary silane layer covalently attached the periodic mesoporous organosilica layer. Depending on the compositions of the layers, the combination of the periodic mesoporous organosilica layer and the secondary silane layer renders the surface of the substrate superhydrophobic or omniphobic. Methods for coating a surface of a substrate include contacting the surface with a mixture of a hydrolyzed organosilane and a poloxamer and curing the mixture on the surface to form a PMO-coated substrate. The methods may further include contacting the PMO-coated article with a secondary silane coating solution of one or more silanes, then curing the secondary silane coating solution to form a dual-coated article comprising a secondary alkylsilane layer covalently attached to the periodic mesoporous organosilica layer on the surface of the substrate.

### CROSS REFERENCE TO RELATED APPLICATIONS

This application depends from and claims priority to U.S. Provisional Application No. 63/017,851 filed Apr. 30, 2020, the entire contents of which are incorporated herein by reference.

### TECHNICAL FIELD

The present application relates generally to hydrophobic and omniphobic coating materials, to coated articles, and to methods for applying the coatings and, more specifically, to superhydrophobic and omniphobic coatings based on mesoporous organic silica, to coated articles, and to methods for applying the coatings.

### BACKGROUND

Liquid-repellent coatings include materials that have tendencies to resist wetting of an underlying substrate by various liquids. Examples of such technologies include superhydrophobic materials and omniphobic materials. Superhydrophobic materials are extremely averse to wetting by polar liquids such as water and typically exhibit a water contact angle of 150° or greater. Omniphobic materials resist wetting by both polar substances and apolar substances, as exhibited by contact angles of 90° or greater both for water and one or more nonpolar solvents.

Superhydrophobic and omniphobic coating materials repel water and/or oil in part because they form a low-surface-energy layer on the substrate surface. Coating materials derived from perfluorinated octanoic acid (PFOA), for example, form low surface-area perfluorinated layers on substrates. The perfluorinated layers in turn protect the substrate against liquids and can also impart self-cleaning abilities to materials. On the other hand, PFOA compounds have been found to be toxic to both the environment and to humans. Because the numerous carbon-fluorine bonds in PFOA compounds are very stable and not easily broken down metabolically, PFOA compounds may bioaccumulate to an unacceptable amount. Ongoing needs exist, therefore, for new materials having superhydrophobic or omniphobic properties without the toxicity concerns raised from compounds including carbon-fluorine bonds.

### BRIEF DESCRIPTION OF THE DRAWINGS

FIG. 1 is a schematic of a coated article according to aspects including a periodic mesoporous organosilane (PMO) layer on a substrate.

FIG. 2 is a schematic of the coated article of FIG. 1 with a water droplet on the coated surface to show hydrophobicity.

FIG. 3 is a schematic of a coated article according to aspects including a periodic mesoporous organosilane (PMO) layer on a substrate and a secondary silane layer on the PMO layer.

FIG. 4 is a schematic of the coated article of FIG. 3 with a water droplet on the coated surface to show superhydrophobicity.

### DETAILED DESCRIPTION

When used to describe certain carbon atom-containing chemical groups, a parenthetical expression having the form “(Cₓ-C_{y})” means that the unsubstituted form of the chemical group has from x carbon atoms to y carbon atoms in its main carbon chain, inclusive of x and y. For example, a (C₁-C₅₀)alkyl is an alkyl group having from 1 to 50 carbon atoms in its unsubstituted form. In some aspects and general structures, certain chemical groups may be substituted by one or more substituents, any of which may include carbon atoms. However, the carbon atoms within the substituent groups are not included in the count for the chemical group defined using the “(Cₓ-C_{y})” parenthetical. For example, a tert-butyl group (—C(CH₃)₃) has a total of four carbon atoms but under the “(Cₓ-C_{y})” convention of this disclosure is considered to be a C₂ alkyl, because the group has a main chain of two carbon atoms, of which the radical carbon is substituted with two methyl groups, as is apparent in the IUPAC radical nomenclature 1,1-dimethylethyl.

The term “(Cₓ-C_{y})alkyl,” where x and y are integers, means a saturated straight or branched hydrocarbon radical of from x to y carbon atoms, that may be unsubstituted or substituted. Examples of unsubstituted (C₁-C₅₀)alkyl include, without limitation, unsubstituted (C₁-C₂₀)alkyl; unsubstituted (C₁-C₁₀)alkyl; unsubstituted (C₁-C₅)alkyl; methyl; ethyl; 1-propyl; 2-propyl (isopropyl); 1-butyl; 2-butyl (iso-butyl); 2-methylpropyl (sec-butyl); 1,1-dimethylethyl (tert-butyl); 1-pentyl; 2,4,4-trimethylpentyl (iso-octyl); 2,2-dimethylpropyl (neopentyl); 1-heptyl; 1-octyl; 1-nonyl; and 1-decyl.

The term “(Cₓ-C_{y})alkylene,” where x and y are integers, means a saturated straight chain or branched chain diradical, in which the radicals are not on ring atoms, of from x to y carbon atoms that is unsubstituted or substituted. Examples of unsubstituted (C₁-C₅₀)alkylene are unsubstituted (C₁-C₂₀)alkylene, including unsubstituted —CH₂CH₂—, —(CH₂)₃—, —(CH₂)₄—, —(CH₂)₅—, —(CH₂)₆—, —(CH₂)₇—, —(CH₂)₈—, —CH₂C*HCH₃, and —(CH₂)₄C*(H)(CH₃), in which “C*” denotes a carbon atom from which a hydrogen atom is removed to form a secondary or tertiary alkyl radical.

The term “periodic” as used herein refers to repeating, but not necessarily ordered, structures that may be interconnected and or discontinuous. Repeating structures need not be identical.

The term “coated” as used herein means one material associating with or otherwise contacting a surface of another material. A coating may be continuous or discontinuous as provided herein.

Reference will now be made in detail to aspects of coated articles exhibiting one or more characteristics of hydrophobicity, superhydrophobicity, and/or omniphobicity without any fluorine containing moieties. The coated articles include a periodic mesoporous organosilica layer and an optional secondary silane layer over the periodic mesoporous organosilica layer. The periodic mesoporous organosilica layers are materials that are stable while in use, but can be degraded to environmentally benign products. Methods for preparing the coated articles will be described subsequently.

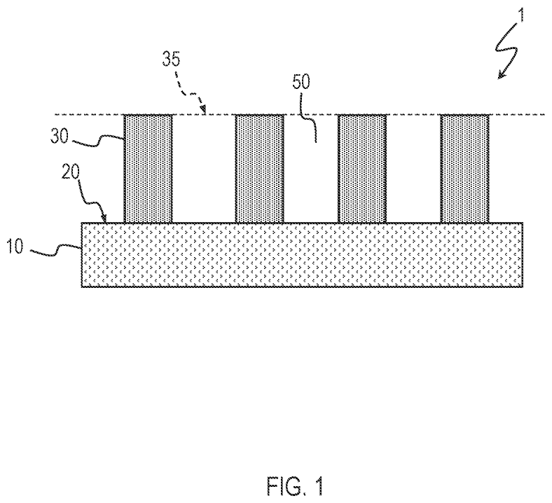

Referring to FIG. 1, a coated article 1 includes a substrate 10 and a periodic mesoporous organosilica layer 30 adhered to a surface 20 of the substrate 10. The adhering of the periodic mesoporous organosilica layer 30 to the surface 20 of the substrate 10 may involve any combination of covalent bonding, and/or hydrogen bonding, and/or van der Waals forces, and/or other intermolecular bonding or adherence mechanisms, depending generally upon the types and numbers of surface groups present on the surface 20 of the substrate 10. In some aspects, the substrate 10 may include surface hydroxyl groups that can interact with the groups of the periodic mesoporous organosilica layer 30 to adhere the periodic mesoporous organosilica layer 30 to the surface 20.

Examples of the substrate 10 include many varieties of materials with hard surfaces or soft surfaces. Example materials with hard surfaces include, without limitation, glasses, metals, wood, or ceramics. Materials with soft surfaces include, without limitation, textiles, fabrics, leather, artificial leather, paper, rubber, and non-wovens. In some aspects, the substrate 10 may include a woven fabric or a nonwoven fabric. In some aspects, the substrate 10 may include a fabric of fibers chosen from, not but limited to, cotton, flax, wool, silk, nylon, aramid, polyester, polyethylene, polypropylene, rayon, cellulose, poly(vinyl chloride), polyethylene terephthalate, acetate, or blends or mixtures of any of the foregoing. In some aspects, the substrate 10 may be any fabric material suitable for use as clothing. In one specific aspect, the substrate 10 may be a cotton fabric. In another specific aspect, the substrate 10 may be a mixed fabric containing a cellulose content of greater than 5% by weight, based on the total weight of the fabric. In yet another specific aspect, the substrate 10 may be a protective fabric such as the military-grade fabric DriFire®, available from National Safety Apparel, or fabrics made of materials as disclosed in one or more of U.S. Pat. Nos. 8,732,863; 8,973,164; 9,034,777; 9,745,674; and 10,030,326; and United States pre-grant publications 2015/0191856 and 2016/0060809, all of which documents are incorporated herein by reference. Such fabrics include a combination of hydrophobic fibers and hydrophilic fibers.

The coated article 1 further includes a periodic mesoporous organosilica layer 30 adhered to the surface of the substrate. Organosilicas include polymerization products of organosilanes in which silicon atoms are bonded to at least one organic group such as an alkyl group or an aryl group, for example. The polymerization products may be generically described as a silicon-oxygen network such as a polysilsesquioxane of the formula O_{1.5}Si—R—SiO_{1.5}, where R is a divalent organic moiety such as an alkylene. Silsesquioxane stoichiometry results from when compounds such as (HO)₃Si—R—Si(OH)₃ are polymerized, whereby upon the polymerization with loss of water molecules, individual oxygen atoms in the silsesquioxane network bond to two silicon atoms as a bridge. Moreover, the polymerization of organosilicon compounds results in organosilicas that have a mesoporous structure, with average pore sizes from about 2 nanometers (nm) to about 50 nm, depending on the identity of the organic groups and the polymerization environment. Owing to the combination of a silicon-oxygen network and organic bridging groups between silicon atoms, the periodic mesoporous organosilica is considered a hybrid organic-inorganic material. The structures are periodic in the sense that they have a highly-ordered repeating structure that may be amorphous or crystalline. In some aspects, the periodic mesoporous organosilica layer 30 may have a pillared structure with pores 50 between individual pillars on the surface 20 of the substrate. Tops of the multiple pillars in form an effective surface 35 over the surface 20 of the substrate. In some aspects, the periodic mesoporous organosilica layer 30 may include a plurality of hexagonally packed columns of organosilica adhered to the substrate 10.

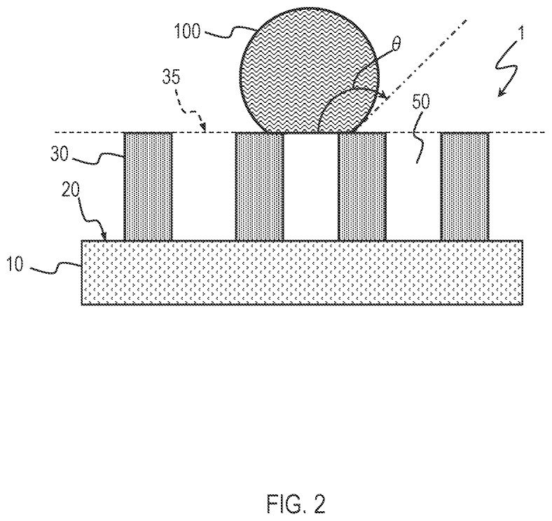

As shown in FIG. 2, a liquid droplet 100 on the effective surface 35 may have a contact angle θ. If the liquid droplet 100 is water, for example, the contact angle θ may be greater than 90° if the effective surface 35 is hydrophobic, for example, or greater than 150° if the effective surface 35 is superhydrophobic.

In aspects of the coated article 1, the periodic mesoporous organosilica layer 30 may include a silica network of polymerized units having a structure (—O)_{1.5}Si-A-Si(O—)_{1.5}, where A is a C₁-C₅₀ alkylene, such as a C₁-C₂₀ alkylene, or a C₂-C₁₀ alkylene. In a specific but nonlimiting example, the periodic mesoporous organosilica layer may include a silica network of polymerized units having a structure (—O)_{1.5}Si-A-Si(O—)_{1.5}, where A is octan-1,8-diyl.

In aspects of the coated article 1, the periodic mesoporous organosilica layer 30 may have an average pore diameter or pore size of from 1 nm to 50 nm, or from 2 nm to 30 nm, or from 2 nm to 20 nm, or from 5 nm to 30 nm, or from 10 nm to 30 nm, or from 20 nm to 30 nm. Without intent to be bound by theory, it is believed that the hydrophobic properties and oleophobic properties of the periodic mesoporous organosilica layer 30 may be correlated to pore sizes of the periodic mesoporous organosilica layer 30.

In aspects of the coated article 1, the periodic mesoporous organosilica layer 30 may have a thickness from 1 nm to 20 μm, or from 10 nm to 20 μm, or from 100 nm to 20 μm, or from 1 μm to 20 μm, or from 10 nm to 1 μm, or from 100 nm to 1 μm, or any subset of any of the foregoing ranges.

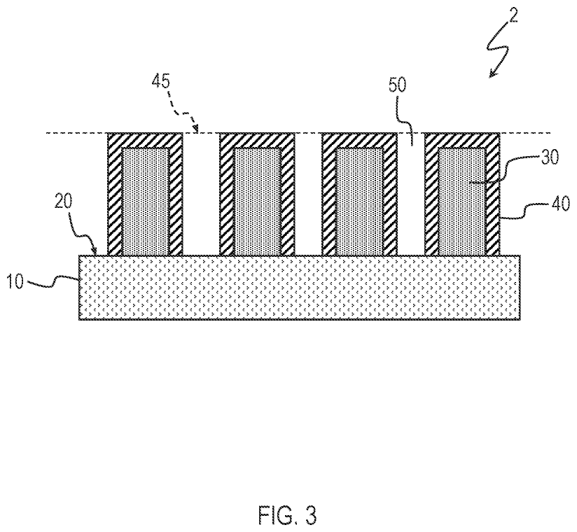

Referring to FIG. 3, in further aspects, the coated article may be a dual-coated article 2. The dual-coated article 2 includes the substrate 10 and the periodic mesoporous organosilica layer 30 as previously described and further includes secondary silane layer 40 covalently attached to the periodic mesoporous organosilica layer 30. Although the secondary silane layer 40 is depicted as coating the periodic mesoporous organosilica layer 30, it is understood that a portion of the secondary silane layer 40 may infiltrate the periodic mesoporous organosilica layer 30 and contact the substrate 10. According to one or more aspects, the secondary silane layer 40 is covalently attached to the periodic mesoporous oragnosilica layer 30 and adhered to the substrate 10. In some aspects, the secondary silane layer 40 is covalently attached to the periodic mesoporous organosilica layer 30 and/or the substrate 10 through silicon-oxygen bonds.

When the coated article is a dual-coated article 2, in some aspects the secondary silane layer 40 may include a network of polymerized units having a structure (—O)₃Si—R¹, where R¹ is a straight-chained or branched C₁-C₅₀ alkyl such as, for example, a straight-chained or branched C₁-C₂₀ alkyl, or a branched C₂-C₂₀ alkyl. In more specific non-limiting aspects, the secondary silane layer 40 may include a network of polymerized units having a structure (—O)₃Si—R¹, where R¹ is a branched C₂-C₂₀ alkyl having a terminal tertiary carbon atom. In such alkyl groups having a terminal tertiary carbon atom, the penultimate carbon atom of the main chain is disubstituted with two non-hydrogen groups. Examples of alkyl groups having a terminal tertiary carbon atom include tert-butyl and iso-octyl. In a specific non-limiting aspect, the secondary silane layer 40 includes a network of polymerized units having a structure (—O)₃Si—R¹, where R¹ is 2,4,4-trimethylpentyl.

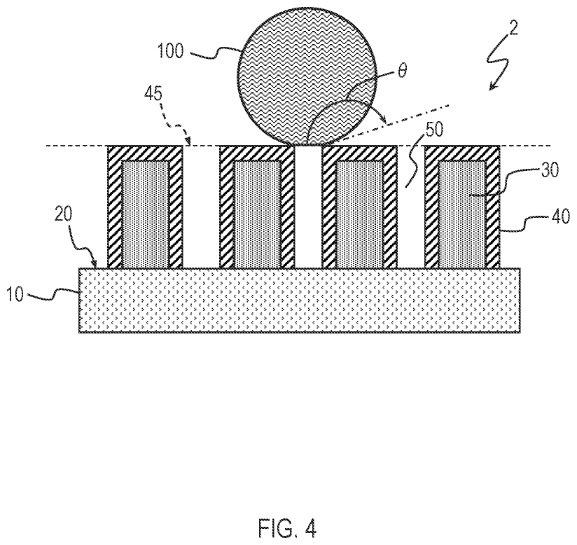

In some aspects of the coated article, when the coated article is a dual-coated article 2 the combination of the periodic mesoporous organosilica layer 30 and the secondary silane layer 40 renders the surface 20 of the substrate 10 superhydrophobic. In particular, the combination of the periodic mesoporous organosilica layer 30 and the secondary silane layer 40 creates an effective surface 45 over the surface 20 of the substrate 10 that is highly resistant to water. As illustrated in FIG. 4, the combination of the periodic mesoporous organosilica layer 30 and the secondary silane layer 40 may render the surface of the substrate superhydrophobic, whereby the dual-coated article 2 exhibits a water contact angle θ greater than 150°, measured according to ASTM D7334, incorporated by reference herein.

In some aspects of the coated article, when the coated article is a dual-coated article 2 the secondary silane layer 40 may include a network of polymerized units chosen from T units, D units, and combinations thereof, in which the T units have a structure (—O)₃Si—R², the D units have a structure (—O)₂Si(R³)(R⁴), and R², R³, and R⁴ are independently C₁-C₂₀ alkyl, or in which R², R³, and R⁴ are independently C₁-C₅ alkyl, or in which R², R³, and R⁴ are identical and are selected from C₁-C₅ alkyl. In a specific non-limiting aspect, the secondary silane layer 40 may include a network of polymerized units chosen from T units, D units, and combinations thereof, in which the T units have a structure (—O)₃Si—R², the D units have a structure (—O)₂Si(R³)(R⁴), and R², R³, and R⁴ are methyl. In example aspect, the network of polymerized units may include T units and D units, in which the network of polymerized units has a molar ratio of T units to D units from 1:100 to 100:1, or from 1:10 to 10:1, or from 1:1 to 10:1, or from 1:1 to 5:1, or about 2:1.

In further aspects of the coated article, when the coated article is a dual-coated article 2 the secondary silane layer 40 may include a network of polymerized units chosen from T units, D units, M units, and combinations thereof, in which the T units have a structure (—O)₃Si—R², the D units have a structure (—O)₂Si(R³)(R⁴), the M units have a structure (—O)Si(R⁵)(R⁶)(R⁷), and R², R³, R⁴, R⁵, R⁶, and R⁷ are independently C₁-C₂₀ alkyl, or in which R², R³, R⁴, R⁵, R⁶, and R⁷ are independently C₁-C₅ alkyl, or in which R², R³, R⁴, R⁵, R⁶, and R⁷ are identical and are selected from C₁-C₅ alkyl. In a specific non-limiting aspect, the secondary silane layer 40 may include a network of polymerized units chosen from T units, D units, M units, and combinations thereof, in which the T units have a structure (—O)₃Si—R², the D units have a structure (—O)₂Si(R³)(R⁴), the M units have a structure (—O)Si(R⁵)(R⁶)(R⁷), and R², R³, R⁴, R⁵, R⁶, and R⁷ are methyl. In example aspect, the network of polymerized units may include T units and D units, and M units, in which the network of polymerized units has a molar ratio of T units to D units from 1:100 to 100:1, or from 1:10 to 10:1, or from 1:1 to 10:1, or from 1:1 to 5:1, or about 2:1, and a molar ratio of [T units+D units] to M units from 5:1 to 1000:1, or from 9:1 to 999:1, or from 10:1 to 1000:1, or from 20:1 to 1000:1, or from 100:1 to 1000:1, or from 500:1 to 1000:1.

In aspects of the coated article, when the coated article is a dual-coated article 2 including a network of polymerized units chosen from T units, D units, M units, and any combination of two or three of T units, and/or D units, and/or M units, the combination of the periodic mesoporous organosilica layer 30 and the secondary silane layer 40 may render the surface of the substrate omniphobic. In particular, the combination of the periodic mesoporous organosilica layer 30 and the secondary silane layer 40 creates an effective surface 45 over the surface 20 of the substrate 10 that are omniphobic and/or superhydrophobic. The omniphobic surface may exhibit a water contact angle greater than 90° and a corn-oil contact angle greater than 90°, measured according to ASTM D7334. In some aspects, the combination of the periodic mesoporous organosilica layer 30 and the secondary silane layer 40 may render the surface of the substrate both superhydrophobic and omniphobic, so as to exhibit a water contact angle greater than 150° and a corn-oil contact angle greater than 90°, measured according to ASTM D7334.

In aspects of the coated article, when the coated article is a dual-coated article 2 the secondary silane layer 40 may have a thickness from 1 nm to 20 μm, or from 10 nm to 20 μm, or from 100 nm to 20 μm, or from 1 μm to 20 μm, or from 10 nm to 1 μm, or from 100 nm to 1 μm, or any subset of any of the foregoing ranges.

In view of the aspects of coated articles 1 including the periodic mesoporous organosilica layer 30 and the dual-coated articles 2 including both the periodic mesoporous organosilica layer 30 and the secondary silane layer 40, methods for coating substrates will now be described.

In general, the methods for coating substrates are based on a one-step process or a two-step process. In either process, the first step forms a periodic mesoporous organosilica layer that is hydrophobic due to trapped air pockets at the water-substrate interface. The periodic mesoporous organosilica layer is formed by applying a mixture of a templating agent and a bisorganosilane. Templating agents create removable temporary structures that guide the formation of the periodic mesoporous organosilica. Examples of templating agents include surfactants. Non-limiting examples of surfactants suitable as templating agents include poloxamers; ionic surfactants such as cetyltrimethyl ammonium bromide (CTAB), sodium dodecyl sulfate (SDS); nonionic surfactants such as Brij (surfactants of a nominal formula EₘCₙ, where Eₘ is hydrophilic chain of m oxyethylene groups E and Cₙ is a hydrophobic alkyl chain having n carbon atoms); and phosphonated poloxamers. Additional examples of suitable templating agents include combinations of dibenzoyl-L-tartaric acid, D-maltose, and D-glucose; combinations of tartaric acid and metal chlorides; long-chain alkoxysilanes; triethanolamine; ethoxylated sorbitan esters; multiwall carbon nanotubes; and cellulose nanocrystals.

In some aspects, the templating agent may be a poloxamer. Poloxamers are polymer surfactants that form varying micelle morphologies based on temperature and polymer concentration in solution. When the poloxamer is suspended in solution, the regions between micelles are filled with the bisorganosilane. The substrate may be coated by any suitable process, followed by a curing step during which the silane attaches to the surface. The modified surface then is washed to remove residual poloxamer from the periodic mesoporous organosilica layer. In a two-step process, during the second step a silane or mixture of silanes is coated onto the periodic mesoporous organosilica layer and cured to covalently bind the silane to the periodic mesoporous organosilica. By varying the structure of the silane, the final properties of the coating can be tuned to a desired level of hydrophobicity, superhydrophobicity, or omniphobicity.

The chemical reaction that attaches the secondary silane layer 40 to the periodic mesoporous organosilica layer 30 is similar to the chemical reaction that attaches the periodic mesoporous organosilica layer 30 to the surface 20 of the substrate 10. For both layers, the activating step includes an acid-catalyzed alkoxysilane hydrolysis. Once the alkoxysilane is hydrolyzed, it exists in an activated state and then is able to react with hydroxyl groups of the substrate. Cellulosic textiles such as cotton, rayon, viscose, and linens, and also many kinds of glasses and ceramics others, all include such surface hydroxyl groups capable of reacting with the hydrolyzed alkoxysilane. In some aspects, the secondary silane layer 40 may be covalently bonded to the periodic mesoporous organosilica layer 30. As previously described, the adhering of the periodic mesoporous organosilica layer 30 to the surface 20 of the substrate 10 may involve any combination of covalent bonding, and/or hydrogen bonding, and/or van der Waals forces, and/or other intermolecular bonding or adherence mechanisms, depending generally upon the types and numbers of surface groups present on the surface 20 of the substrate 10.

Aspects of methods for coating a surface of a substrate include contacting the surface of the substrate with a coating mixture, curing the coating mixture on the surface to allow the hydrolyzed organosilane to polymerize and form a PMO-coated article comprising a periodic mesoporous organosilica layer adhered to the surface of the substrate; and removing residual templating agent from the PMO-coated article after the curing. In such aspects, the coating mixture includes a hydrolyzed organosilane of formula (HO)₃Si-A-Si(OH)₃, where A is a C₁-C₅₀ alkylene; and a templating agent. The templating agent may be any of the templating agents previously described herein or any combination thereof. In some aspects, the templating agent is a poloxamer.

In example aspects of methods for coating a surface of a substrate in which the templating agent is a poloxamer, the methods may include contacting the surface of the substrate with a coating mixture, curing the coating mixture on the surface to allow the hydrolyzed organosilane to polymerize and form a PMO-coated article comprising a periodic mesoporous organosilica layer adhered to the surface of the substrate; and removing residual poloxamer from the PMO-coated article after the curing. In such aspects, the coating mixture includes a hydrolyzed organosilane of formula (HO)₃Si-A-Si(OH)₃, where A is a C₁-C₅₀ alkylene; and a poloxamer of structure HO—(PEO)ₐ(PPO)_{b}(PEO)ₐ—H. In the poloxamer, each PEO is a polyoxyethylene unit (—CH₂CH₂O—); PPO is a polyoxypropylene unit (—CH₂CH(CH₃)O—); subscripts a and b refer to degrees of polymerization, namely, the number of PEO or PPO units in a contiguous block of the copolymer; subscript a is an integer from 2 to 130 and is the same in both instances; and subscript b is from 15 to 100.

As described, the methods for coating the surface of the substrate include contacting the surface of the substrate with a coating mixture that includes a hydrolyzed organosilane and a poloxamer. In aspects, the coating mixture is a liquid. Thus, the surface of the substrate may be contacted with the coating mixture by any technically feasible method for bringing a liquid into contact with a solid surface to form a well-distributed layer on the surface or a uniform layer on the surface. In some aspects, contacting the surface of the substrate with the coating mixture may include dip coating the substrate with the coating mixture. Dip coating may include dipping the substrate into the coating mixture and subsequently removing the dipped substrate from the coating mixture. In other aspects, contacting the surface of the substrate with the coating mixture may include spraying the coating mixture onto the substrate surface. In further aspects, contacting the surface of the substrate with the coating mixture may include roll coating the coating mixture onto the substrate surface.

In the methods for coating the surface of the substrate according to aspects, the substrate may be any of the substrates previously described in this disclosure with respect to the coated articles. For example, the substrate may include a textile, a glass, a metal, a plastic, leather, artificial leather, wood, paper, rubber, or a ceramic. Illustrative examples of an artificial leather include, but are not limited to polymer coated surfaces or textiles such as polyurethane coated onto a polyester substrate sold as POROMERICS, or poly(vinyl chloride) coated textile materials sold as LEATHERETTE. As further examples, a textile may include a woven fabric or a nonwoven fabric. As further examples, the substrate may include a fabric of fibers such as cotton, flax, wool, silk, nylon, aramid, polyester, polyethylene, polypropylene, rayon, cellulose, poly(vinyl chloride), polyethylene terephthalate, acetate, or blends or mixtures of any of the foregoing.

The coating mixture includes a hydrolyzed organosilane and a poloxamer. In some aspects, the methods for coating the surface of the substrate may include mixing a first solution comprising the hydrolyzed organosilane with a second solution comprising the poloxamer to prepare the coating mixture. The relative amounts of the first solution and the second solution that are combined to form the coating mixture, particularly the relative amounts of hydrolyzed organosilane and poloxamer, and the concentration of the poloxamer may be adjusted to influence the structural characteristics of the periodic mesoporous organosilica layer that results from the coating process.

In aspects, the hydrolyzed organosilane has formula (HO)₃Si-A-Si(OH)₃, where A is a C₁-C₅₀ alkylene. In further aspects, the hydrolyzed organosilane has formula (HO)₃Si-A-Si(OH)₃, where A is a C₁-C₂₀ alkylene. In further aspects, the hydrolyzed organosilane has formula (HO)₃Si-A-Si(OH)₃, where A is a C₂-C₁₀ alkylene. Examples of C₂-C₁₀ alkylene include straight-chained or branched alkylenes. Examples of straight-chained C₂-C₁₀ alkylenes include ethan-1,2-diyl, propan-1,3-diyl, butan-1,4-diyl, pentan-1,5-diyl, hexan-1,6-diyl, heptan-1,7-diyl, octan-1,8-diyl, nonan-1,9-diyl, decan-1,10-diyl. In a specific aspect, the hydrolyzed organosilane has formula (HO)₃Si-A-Si(OH)₃, where A is octan-1,8-diyl.

The methods for coating the surface of the substrate optionally may further include combining an organosilane with an acidified polar solvent to hydrolyze the organosilane and form the first solution. In such aspects, the organosilane may be a bis(trialkoxylsilyl)alkane compound having the formula (XO)₃Si-A-Si(OX)₃, where each X is a C₁-C₂₀ alkyl and A is a C₁-C₅₀ alkylene. The alkylene A in the bis(trialkoxylsilyl)alkylene compound is the same as the alkylene A of the hydrolyzed organosilane in the coating mixture. In specific example aspects, each X may be methyl or ethyl. In further specific example aspects, each X may be ethyl. In one specific example aspect, the organosilane may be 1,2-bis(triethoxysilyl)ethane. In another specific example aspect, the organosilane may be 1,8-bis(triethoxysilyl)octane. When the organosilane is combined with an acidified or basified polar solvent, the alkoxy groups of the organosilane hydrolyze to hydroxyl groups. In aspects, the polar solvent may be any solvent capable of hydrolyzing alkoxy groups of a silane compound. Specific examples of such polar solvents include alcohols and water. The polar solvent may be acidified with a mineral acid such as hydrochloric acid, or basified with a base such as sodium hydroxide. In an example aspect, the acidified polar solvent is ethanol acidified with hydrochloric acid so that the acidified polar solvent has a concentration of hydrochloric acid of about 0.01 M.

The coating mixture in some aspects further includes a poloxamer of structure HO—(PEO)ₐ(PPO)_{b}(PEO)ₐ—H. Poloxamers in general are triblock copolymers consisting of a polyoxypropylene hydrophobic core block surrounded by two hydrophilic polyoxyethylene blocks of equal lengths. Thus, in the poloxamer of the coating mixture, each PEO is a polyoxyethylene unit (—CH₂CH₂O—), and each PPO is a polyoxypropylene unit (—CH₂CH(CH₃)O—). The subscripts a and b refer to degrees of polymerization, namely, the number of PEO or PPO units in the blocks of the copolymer. In aspects, subscript a is an integer from 2 to 130 and is the same in both instances; and subscript b may be from 15 to 100.

Many different poloxamers exist that have properties that vary based on the total molecular weight of the copolymer and the and relative amounts of PEO and PPO in the copolymer HO—(PEO)ₐ(PPO)_{b}(PEO)ₐ—H. Generic poloxamers are named by a convention in which the letter P (for poloxamer) is followed by three digits (for example, “poloxamer P ###”). In this convention, the first two digits multiplied by 100 give a rough approximation for the molecular mass of the polyoxypropylene core, and the last digit multiplied by 10 gives the mass percent of polyoxyethylene units in the copolymer. Thus, as an example, P407 by generic notation is a poloxamer with a polyoxypropylene mass component of 4000 g/mol and a 70% polyoxyethylene content by mass (thus, also 30% polyoxypropylene by mass), based on the total mass of the poloxamer. Accordingly, the molecular mass of the P407 as a whole is approximately 13,333 g/mol, as computed from the polyoxypropylene component divided by 0.30. For the Pluronic and Synperonic tradenames, coding of these copolymers starts with a letter to define its physical form at room temperature (L=liquid, P=paste, F=flake (solid)) followed by two or three digits. The first digit (or the first two digits in a three-digit number) in the numerical designation, multiplied by 300, is a rough approximation of molecular weight of the polyoxypropylene; and the last digit multiplied by 10 gives the percentage polyoxyethylene content by mass. As an example of this convention, L61 indicates a copolymer with a polyoxypropylene molecular mass of 1800 g/mol and a 10% polyoxyethylene content. In the example given, poloxamer 181 (P181) by the generic convention is equivalent to Pluronic L61 and Synperonic PE/L 61.

For reference, a single polyoxyethylene unit has a mass of about 44.05 g/mol; a single polyoxypropylene unit has a mass of about 58.08 g/mol; and the terminal hydrogen and hydroxide together have a mass of about 18.02 g/mol. It should be understood that the references to molecular mass in the conventional numbering designations of generic poloxamers, including for tradenames such as Pluronic and Synperonic, are often very rough approximations that do not substitute for molecular mass numbers computed from knowing the actual average numbers of PPO and PEO units in the copolymers. It should be understood also that poloxamers vary in chemical behavior with respect to hydrophilic-lipophilic balance (HLB), which value is based on the relative numbers of PEO and PPO units in the block copolymer.

Without intent to be bound by theory, it is believed that the selection of the poloxamer and the hydrolyzed organosilane for the coating mixture, and also the concentration of the poloxamer in the coating mixture and the temperature of the coating mixture, influence the overall structure and morphology of the resulting periodic mesoporous organosilica layer. When the hydrolyzed organosilane and the poloxamer are combined, the hydrolyzed organosilane organizes itself into micelles within a continuous phase of the poloxamer. Upon contact with the surface of the substrate, the arrangement of the micelles within the coating mixture provides a template for the growth of the periodic mesoporous organosilica layer on the surface of the substrate.

In non-limiting example aspects of methods for coating a surface of a substrate, the poloxamer may be chosen from poloxamers of the general formula HO—(PEO)ₐ(PPO)_{b}(PEO)ₐ—H having total molecular weights of from 1500 g/mol to 15,000 g/mol and polyoxyethylene contents of from 10% by weight to 80% by weight, based on the total weight of the poloxamer. In one specific aspect, the poloxamer may be poloxamer 403 according to the generic naming convention previous described. Poloxamer P403 is equivalent to Pluronic P123 (available from BASF), which is a poloxamer of formula HO—(PEO)ₐ(PPO)_{b}(PEO)ₐ—H, in which subscript a is 20 in both instances and subscript b is 70, having a molecular weight of about 5800 g/mol and a polyoxyethylene content of 30% by weight, based on the total weight of the poloxamer.

The methods for coating the surface of the substrate further include curing the coating mixture on the surface of the substrate to allow the hydrolyzed organosilane to polymerize. Upon polymerization of the hydrolyzed organosilane, a periodic mesoporous organosilica layer is formed, resulting in a PMO-coated article having the periodic mesoporous organosilica layer attached to the surface of the substrate. In aspects, curing the coating mixture may include exposing the coated substrate to heat at a temperature sufficiently high to initiate and enable propagation of the polymerization reaction, yet sufficiently low to avoid reaction kinetics not amenable to forming a stable periodic mesoporous organosilica template. The exposure to heat may be maintained for a time sufficiently to ensure formation of the periodic mesoporous organosilica template yet sufficiently short to avoid overcuring and undesirable surface morphologies. In example aspects, curing the coating mixture may include heating the coated substrate in an oven or other suitable apparatus at from 30° C. to 200° C., or from 50° C. to 150° C., or from 75° C. to 125° C., or about 100° C., for from 15 minutes to 120 minutes, or from 15 minutes to 60 minutes, or from 15 minutes to 30 minutes, or from 30 minutes to 60 minutes, or about 30 minutes. In a specific non-limiting example, curing the coating mixture may include heating the coating mixture on the substrate at 100° C. for 30 minutes.

The methods for coating the surface of the substrate further include removing residual poloxamer from the PMO-coated article after the curing. Once the hydrolyzed organosilane has cured on the surface of the substrate under the templating influence of the poloxamer in the coating mixture, the organosilane has reacted to form the periodic mesophase organosilica attached to the substrate, but the poloxamer may remain unreacted on the surfaces of the substrate and on the surfaces of the periodic mesophase organosilica layer. The residual poloxamer, if not removed, may inhibit or prevent the PMO-coated article from exhibiting hydrophobicity. Thus, in aspects, the residual poloxamer may be removed by washing the PMO-coated article in a solvent having affinity to or miscibility with the poloxamer. In some aspects, the solvent may be a polar solvent such as an alcohol. In a specific example aspect, the solvent may be ethanol. The PMO-coated article may be immersed in a bath of the solvent from one to ten times. Optionally, sonication, agitation, heating or a combination may be applied to assist the removing of the poloxamer.

The methods for coating the surface of the substrate may further include contacting the PMO-coated article with a secondary silane coating solution and subsequently curing the secondary silane coating solution to form a dual-coated article according to aspects previously described in this disclosure. The dual-coated articles include the periodic mesoporous organosilane layer on the substrate, to which a secondary silane layer is covalently attached. The secondary silane layer includes organic groups that modify the surface characteristics of the periodic mesoporous organosilane layer and may impart superhydrophobicity and/or omniphobicity to the surface of the substrate.

The PMO-coated article may be contacted with the secondary silane coating solution by any of the techniques that were appropriate for contacting the uncoated substrate with the coating mixture from which the periodic mesoporous organosilica layer was derived. Thus, contacting the PMO-coated article with the secondary silane coating solution may include any technically feasible method for bringing a liquid into contact with a solid surface to form a well-distributed layer on the surface or a uniform layer on the surface. In some aspects, contacting the PMO-coated article with the secondary silane coating solution may include dip coating the PMO-coated article with the secondary silane coating solution. Dip coating may include dipping the PMO-coated article into the secondary silane coating solution and subsequently removing the dipped PMO-coated article from the secondary silane coating solution. In other aspects, contacting the PMO-coated article with the secondary silane coating solution may include spraying the secondary silane coating solution onto the PMO-coated article surface.

In some aspects, the secondary silane coating solution includes at least one hydrolyzed alkylsilane. In some aspects, the secondary silane coating solution includes at least one hydrolyzed alkylsilane chosen from hydrolyzed monoalkylsilanes of formula (HO)₃SiR¹, where R¹ is a straight-chained or branched C₁-C₅₀ alkyl.

In other aspects, the secondary silane coating solution includes a combination of hydrolyzed alkylsilanes, wherein the combination comprises at least one alkylsilane from any two or all three of groups (a), (b), and (c): (a) a hydrolyzed monoalkylsilane of formula (HO)₃SiR², where R² is a straight-chained or branched C₁-C₂₀ alkyl; (b) a hydrolyzed dialkylsilane of formula (HO)₂SiR³R⁴, where R³ and R⁴ are independently straight-chained or branched C₁-C₂₀ alkyl; and (c) a hydrolyzed trialkylsilane of formula (HO)SiR⁵R⁶R⁷, where R⁵, R⁶, and R⁷ are independently straight-chained or branched C₁-C₂₀ alkyl. Thus, in some aspects, the secondary silane coating solution may include a combination of at least one hydrolyzed monoalkylsilane of group (a) and at least one hydrolyzed dialkylsilane of group (b). In some aspects, the secondary silane coating solution may include a combination of at least one hydrolyzed monoalkylsilane of group (a) and at least one hydrolyzed trialkylsilane of group (c). In some aspects, the secondary silane coating solution may include a combination of at least one hydrolyzed dialkylsilane of group (b) and at least one hydrolyzed trialkylsilane of group (c). In some aspects, the secondary silane coating solution may include a combination of at least one hydrolyzed monoalkylsilane of group (a), at least one hydrolyzed dialkylsilane of group (b), and at least one hydrolyzed trialkylsilane of group (c).

In examples of aspects in which the secondary silane coating solution includes at least one hydrolyzed alkylsilane chosen from hydrolyzed monoalkylsilanes of formula (HO)₃SiR¹, the at least one hydrolyzed alkylsilane is a hydrolyzed monoalkylsilane of formula (HO)₃SiR¹, where R¹ may be a branched C₂-C₂₀ alkyl. In further examples of aspects in which the secondary silane coating solution includes at least one hydrolyzed alkylsilane chosen from hydrolyzed monoalkylsilanes of formula (HO)₃SiR¹, the at least one hydrolyzed alkylsilane may be a hydrolyzed monoalkylsilane of formula (HO)₃SiR¹, where R¹ is a branched C₂-C₂₀ alkyl comprising a terminal tertiary carbon atom. In further examples of aspects in which the secondary silane coating solution includes at least one hydrolyzed alkylsilane chosen from hydrolyzed monoalkylsilanes of formula (HO)₃SiR¹, the at least one hydrolyzed alkylsilane is a hydrolyzed monoalkylsilane of formula (HO)₃SiR¹, where R¹ may be 2,4,4-trimethylpentyl (iso-octyl). Without intent to be bound by theory, it is believed that particularly in the aspects in which the secondary silane coating solution includes at least one hydrolyzed alkylsilane chosen from hydrolyzed monoalkylsilanes of formula (HO)₃SiR¹, the combination of the periodic mesoporous organosilica layer and the secondary silane layer renders the surface of the substrate superhydrophobic, whereby the coated article exhibits a water contact angle greater than 150°, measured according to ASTM D7334.

In examples of aspects in which the secondary silane coating solution includes a combination of a hydrolyzed monoalkylsilane of formula (HO)₃SiR² and a hydrolyzed dialkylsilane of formula (HO)₂SiR³R⁴, the at least one hydrolyzed alkylsilane may be a combination of a hydrolyzed monoalkylsilane of formula (HO)₃SiR² and a hydrolyzed dialkylsilane of formula (HO)₂SiR³R⁴, where R², R³, and R⁴ are independently straight-chained or branched C₁-C₂₀ alkyl. In further examples of aspects in which the secondary silane coating solution includes a combination of a hydrolyzed monoalkylsilane of formula (HO)₃SiR² and a hydrolyzed dialkylsilane of formula (HO)₂SiR³R⁴, the at least one hydrolyzed alkylsilane may be a combination of a hydrolyzed monoalkylsilane of formula (HO)₃SiR² and a hydrolyzed dialkylsilane of formula (HO)₂SiR³R⁴, where R², R³, and R⁴ are independently straight-chained or branched C₁-C₅ alkyl. In still further examples of aspects in which the secondary silane coating solution includes a combination of a hydrolyzed monoalkylsilane of formula (HO)₃SiR² and a hydrolyzed dialkylsilane of formula (HO)₂SiR³R⁴, the at least one hydrolyzed alkylsilane may be a combination of a hydrolyzed monoalkylsilane of formula (HO)₃SiR² and a hydrolyzed dialkylsilane of formula (HO)₂SiR³R⁴, where R², R³, and R⁴ are identical and are selected from C₁-C₅ alkyl. In a specific example aspect in which the secondary silane coating solution includes a combination of a hydrolyzed monoalkylsilane of formula (HO)₃SiR² and a hydrolyzed dialkylsilane of formula (HO)₂SiR³R⁴, the at least one hydrolyzed alkylsilane is a combination of a hydrolyzed monoalkylsilane of formula (HO)₃SiR² and a hydrolyzed dialkylsilane of formula (HO)₂SiR³R⁴, where R², R³, and R⁴ are methyl, that is, a combination of a monomethyltrisilanol and a dimethyldisilanol.

Additional aspects include each of the previously described aspects in which the secondary silane coating solution includes a combination of a hydrolyzed monoalkylsilane of formula (HO)₃SiR² and a hydrolyzed dialkylsilane of formula (HO)₂SiR³R⁴, in which the secondary silane coating solution further includes at least one hydrolyzed trialkylsilane of formula (HO)SiR⁵R⁶R⁷.

In examples of aspects in which the secondary silane coating solution includes a combination of a hydrolyzed monoalkylsilane of formula (HO)₃SiR² and a hydrolyzed dialkylsilane of formula (HO)₂SiR³R⁴, a molar ratio of the hydrolyzed monoalkylsilane and the hydrolyzed dialkylsilane in the secondary silane coating solution may be from 1:100 to 100:1, or from 1:10 to 10:1, or from 1:1 to 10:1, or from 1:1 to 5:1, or about 2:1, for example. In aspects in which the secondary silane coating solution includes a combination including hydrolyzed trialkylsilane of formula (HO)SiR⁵R⁶R⁷ and one or both of a hydrolyzed monoalkylsilane of formula (HO)₃SiR² and/or a hydrolyzed dialkylsilane of formula (HO)₂SiR³R⁴, the molar ratio of [hydrolyzed monoalkylsilane plus hydrolyzed dialkylsilane] to hydrolyzed trialkylsilane in the secondary silane coating solution may be, for example, from 5:1 to 1000:1, or from 9:1 to 999:1, or from 10:1 to 1000:1, or from 20:1 to 1000:1, or from 100:1 to 1000:1, or from 500:1 to 1000:1. It should be readily understood that, in the secondary alkylsilane coating layer formed upon curing of the secondary silane coating solution, the hydrolyzed monoalkylsilanes of the secondary silane coating solution form the T units of the secondary alkylsilane coating layer, as previously described. Likewise, the hydrolyzed dialkylsilanes of the secondary silane coating solution form the D units of the secondary alkylsilane coating layer, as previously described, and the hydrolyzed trialkylsilanes of the secondary silane coating solution form the M units of the secondary alkylsilane coating layer, as previously described.

The methods for coating the surface of the substrate optionally may further include combining at least one alkylalkoxysilane and an acidic or basic solvent to prepare the secondary silane coating solution. In aspects, the acidic solvent may be any solvent capable of hydrolyzing alkoxy groups of a silane compound. Specific examples of such solvents include polar solvents such as alcohols and water. The polar solvent may be acidified with a mineral acid such as hydrochloric acid or basified with a base such as sodium hydroxide. In an example aspect, the acidified polar solvent is ethanol acidified with hydrochloric acid so that the acidified polar solvent has a concentration of hydrochloric acid of about 0.01 M.

In example aspects, the at least one alkylalkoxysilane may be chosen from monoalkyltrialkoxysilanes of formula (XO)₃SiR¹, where R¹ is a straight-chained or branched C₁-C₅₀ alkyl. In further example aspects, the at least one alkylalkoxysilane may be a combination of alkylalkoxysilanes, in which the combination includes at least one alkylalkoxysilane from any two or all three of groups (a), (b), and (c): (a) a monoalkyltrialkoxysilane of formula (XO)₃SiR² where R² is a straight-chained or branched C₁-C₂₀ alkyl; (b) a dialkyldialkoxysilane of formula (XO)₂SiR³R⁴, where R³ and R⁴ are independently straight-chained or branched C₁-C₂₀ alkyl; and (c) a trialkylalkoxysilane of formula (XO)SiR⁵R⁶R⁷, where R⁵, R⁶, and R⁷ are independently straight-chained or branched C₁-C₂₀ alkyl. In each instance of the formulas for the monoalkyltrialkoxysilanes, the dialkyldialkoxysilanes, and the trialkylalkoxysilanes each X is independently a C₁-C₂₀ alkyl or, in specific example aspects, each X is independently methyl or ethyl or, in further specific example aspects, each X is ethyl. In each instance of the formulas for the monoalkyltrialkoxysilanes, the dialkyldialkoxysilanes, and the trialkylalkoxysilanes, the groups R¹, R², R³, R⁴, R⁵, R⁶, and R⁷ are identical within the scope of the method to corresponding groups R¹, R², R³, R⁴, R⁵, R⁶, and R⁷ of the hydrolyzed monoalkylsilanes, the hydrolyzed dialkylsilanes, and the hydrolyzed trialkylsilanes in the secondary silane coating solution. Accordingly, in a specific example aspect in which the secondary silane coating solution includes at least one hydrolyzed alkylsilane chosen from hydrolyzed monoalkylsilanes of formula (HO)₃SiR¹, the at least one alkylalkoxysilane may be (2,4,4-trimethylpentyl)triethoxysilane. In a specific example aspect in which the secondary silane coating solution includes a combination of a hydrolyzed monoalkylsilane of formula (HO)₃SiR² and a hydrolyzed dialkylsilane of formula (HO)₂SiR³R⁴, the at least one alkylalkoxysilane may be a combination of a methyltriethoxysilane and dimethyldiethoxy silane in a molar ratio of from 1:100 to 100:1.

Without intent to be bound by theory, it is believed that particularly in the aspects in which the secondary silane coating solution includes a combination of a hydrolyzed monoalkylsilane of formula (HO)₃SiR² and a hydrolyzed dialkylsilane of formula (HO)₂SiR³R⁴, the combination of the periodic mesoporous organosilica layer and the secondary silane layer renders the surface of the substrate omniphobic. In such instances, the coated article prepared according to aspects of this disclosure may exhibit a water contact angle greater than 150° and contact angle greater than 90° for non-polar solvents such C₆-C₁₀ alkanes or oils such as corn-oil, each measured according to ASTM D7334.

The methods for coating the surface of the substrate may further include curing the secondary silane coating solution on the PMO-coated article to allow the at least one alkylsilane to polymerize. Upon polymerization of the secondary silane coating solution, a dual-coated article is formed that includes a secondary alkylsilane layer covalently attached to the periodic mesoporous organosilica layer on the surface of the substrate. In aspects, curing the secondary silane coating solution may include exposing the PMO-coated article to heat at a temperature sufficiently high to initiate and enable propagation of the polymerization reaction, yet sufficiently low to avoid reaction kinetics not amenable to forming a stable secondary silane coating layer. The exposure to heat may be maintained for a time sufficiently to ensure formation of the secondary silane coating layer yet sufficiently short to avoid overcuring and undesirable surface morphologies. In example aspects, curing the secondary silane coating solution may include heating the PMO-coated article in an oven or other suitable apparatus at from 50° C. to 150° C., or from 75° C. to 125° C., or about 100° C., for from 15 minutes to 120 minutes, or from 15 minutes to 60 minutes, or from 15 minutes to 30 minutes, or from 30 minutes to 60 minutes, or about 30 minutes. In a specific example aspect, curing the secondary silane coating solution may include heating the secondary silane coating solution on the PMO-coated article at 100° C. for 30 minutes.

Without intent to be bound by theory, it is believed that in the second coating step during which the secondary silane layer is formed, greater hydrophobicity and omniphobicity are achieved. Furthermore, it is believed that the periodic mesoporous organosilica coating is tailorable to optimize desirable properties through manipulation of reaction and process parameters, including the selection of the components and component ratios within the secondary silane coating solution.

### EXAMPLES

The present invention will be better understood by reference to the following examples, which are offered by way of illustration and which one skilled in the art will recognize are not meant to be limiting. General coating procedures will now be described. Test samples prepared according to the general procedures are described in Examples 1-8. Characterizations of the test samples according to Examples 1-8 are described in Example 9.

### PMO Coating Procedure

Test samples described in this application are prepared by dip coating into a coating solution, followed by curing and washing. To prepare the coating solution, a Poloxamer solution is prepared by dissolving 0.691 g Poloxamer P123 in 2.168 g of ethanol. At the same time in a separate container, an organosilane solution is prepared by combining 2.61 mL of the organosilane [1,8-bis(triethoxysilyl)octane] and 3.00 mL of 0.01-M hydrochloric acid in ethanol and allowing the organosilane to hydrolyze. The hydrolyzed organosilane solution is stirred for approximately twenty minutes and then is poured into the Poloxamer solution. The resulting mixture is stirred briefly by hand and allowed to self-assemble for one hour, whereupon the mixture is ready for use as the coating solution.

To coat a test sample, the sample is dipped into the coating solution and removed, then allowed to partially dry on a paper towel in a fume hood. The sample then is transferred to an oven and cured at 100° C. for 30 minutes. Samples are promptly removed from the oven after the 30 minutes to prevent over curing. The cured sample is placed into an ethanol bath to remove residual Poloxamer, then removed from the ethanol bath. The ethanol bath step is repeated three times to ensure full removal of the Poloxamer.

### Secondary Silane Coating Procedure

A secondary silane coating is applied to a sample coated with PMO, as previously described, by dip coating into a secondary silane coating solution, drying, and curing.

The secondary silane coating solution is prepared by mixing equal volumes of a silane component and a solution of 0.01 M hydrochloric acid in ethanol. The silane component may be a single silane compound or a combination of multiple silane compounds. The mixture is stirred for at least one hour to allow the silanes to hydrolyze.

To apply the secondary silane coating to the PMO-coated test sample, the test sample is dipped into the coating solution and removed. The dipped sample is partially dried at room temperature then transferred into an oven to cure at 100° C. for thirty minutes. The application steps for coating with the secondary silane may be repeated one or more times to increase superhydrophobicity or omniphobicity of the coated test sample.

### Example 1

PMO Coating on 100% Cotton

To a sample of 100% cotton cloth, a PMO coating was applied by dip coating, following the PMO Coating Procedure as previously described.

### Example 2

### PMO+Isooctylsilane Coating on 100% Cotton

To a sample of 100% cotton cloth, a PMO coating was applied by dip coating, following the PMO Coating Procedure as previously described. To the resulting coated sample, a secondary silane coating was applied, following the Secondary Silane Coating Procedure as previously described, in which the silane component was isooctylsilane.

### Example 3

### PMO Coating on Mixed Textile (15% Cellulose)

To a sample of mixed textile including 15% cellulose, a PMO coating was applied by dip coating, following the PMO Coating Procedure as previously described.

### Example 4

### PMO+Isooctylsilane Coating on Mixed Textile (15% Cellulose)

To a sample of mixed textile including 15% cellulose, a PMO coating was applied by dip coating, following the PMO Coating Procedure as previously described. To the resulting coated sample, a secondary silane coating was applied, following the Secondary Silane Coating Procedure as previously described, in which the silane component was isooctylsilane.

### Example 5

### PMO+MMS/DMS Coating on Mixed Textile (15% Cellulose)

To a sample of mixed textile including 15% cellulose, a PMO coating was applied by dip coating, following the PMO Coating Procedure as previously described. To the resulting coated sample, a secondary silane coating was applied, following the Secondary Silane Coating Procedure as previously described, in which the silane component was a mixture of 2 parts by weight monomethylsilane to 1 part by weight dimethylsilane.

### Example 6

### PMO Coating on DriFire®

To a sample of DriFire®, a PMO coating was applied by dip coating, following the PMO Coating Procedure as previously described.

### Example 7

### PMO+Isooctylsilane Coating on DriFire®

To a sample of DriFire®, a PMO coating was applied by dip coating, following the PMO Coating Procedure as previously described. To the resulting coated sample, a secondary silane coating was applied, following the Secondary Silane Coating Procedure as previously described, in which the silane component was isooctylsilane.

### Example 8

### PMO+MMS/DMS Coating on DriFire®

To a sample of DriFire®, a PMO coating was applied by dip coating, following the PMO Coating Procedure as previously described. To the resulting coated sample, a secondary silane coating was applied, following the Secondary Silane Coating Procedure as previously described, in which the silane component was a mixture of 2 parts by weight monomethylsilane to 1 part by weight dimethylsilane.

### Example 9

### Characterizations of Coated Test Samples

The samples prepared according to Examples 1-8 were characterized with respect to contact angles of various liquids on surfaces of the samples, to durability of the coatings with respect to laundering, to breathability, to tensile strength, to weight gain, and to color changes imparted on the substrates

### Contact Angles

Contact angle measurements describe an angle that defined by a liquid-vapor interface between a liquid droplet and a surface onto which the liquid droplet is applied. Contact angle measurements correlate with the static resistance of the surface to the liquid. A contact angle of 0° signifies that the liquid fully wets the surface and that the surface is perfectly wettable by the liquid. A contact angle of 180° signifies that the liquid droplet remains completely spherical upon the surface and that the surface is non-wettable by the liquid. Contact angles greater than 0° to 90° signify that the surface is highly wettable by the liquid or “philic” to the liquid. Contact angles between 90° and 150° signify that the surface has a low degree of wettability by the liquid or is “phobic” to the liquid. Contact angles from 150° to 180° signify that the surface has a very low degree of wettability by the liquid or is “superphobic” to the liquid.

PMO-based coatings, both with and without a secondary silane coating, were applied to various fabric substrates as described in Examples 1-5 of this application. Contact angles were measured in each instance according to ASTM D7334. The following Table summarizes the data:

TABLE 1

| | | Primary | Secondary | | Contact |
|---|---|---|---|---|---|
| Ex. | Substrate | Coating | Coating | Liquid | Angle |
| 1 | 100% Cotton | PMO | — | Water | ~120° |
| 2 | 100% Cotton | PMO | isooctylsilane | Water | >150° |
| 3 | Mixed Textile | PMO | — | Water | ~120° |
| | (15% cellulose) | | | | |
| 4 | Mixed Textile | PMO | isooctylsilane | Water | >150° |
| | (15% cellulose) | | | | |
| 5 | Mixed Textile | PMO | MMS + DMS | Water | 150° |
| | (15% cellulose) | | (2:1 w/w) | | |
| 5 | Mixed Textile | PMO | MMS + DMS | Corn oil | >100° |
| | (15% cellulose) | | (2:1 w/w) | | |

MMS = monomethylsilane;
DMS = dimethylsilane

### Laundering

Cotton samples prepared according to Example 2 and mixed textile samples prepared according to Examples 4 were taken through a simulated laundering process for 20 cycles. Before the laundering process, all of these samples were coated with PMO and isooctylsilane and exhibited superhydrophobic water contact angles. Comparative samples were prepared by coating a cotton sample and a mixed textile sample with only a secondary silane coating but no underlying PMO coating. The comparative samples were initially hydrophobic. The comparative samples were subjected to the same laundering process for 20 cycles as were the samples according to Examples 2 and 4.

After the 20 laundering cycles, water contact angles were assessed for the comparative samples and the samples according to Examples 2 and 4. The comparative samples without the PMO layer were no longer hydrophobic and wetted. Samples according to Examples 2 and 4, having PMO and isooctylsilane coatings, exhibited water contact angles less than those measured before the laundering process but nevertheless maintained hydrophobic properties. Without intent to be bound by theory, it is believed that this experiment demonstrates that the coatings prepared according to the Examples of this application would be durable under normal use.

### Breathability—Cotton

Cotton samples prepared according to Examples 1 and 2 of this disclosure were run through the ASTM E 96 Standard for Water Vapor Transmission of Materials using the water method as described in the standard. Uncoated cotton fabric samples, bleached or unbleached, were assessed as a comparative control. The test method measures the weight of water lost as vapor transmitted through the tested material.

Samples of each type of cotton were run in triplicate in a humidity chamber set to 21° C. and 50% relative humidity. No meaningful difference in the water vapor transmission rate was observed over the course of three days between the uncoated control samples, the PMO-only samples according to Example 1, or the PMO+isooctylsilane samples according to Example 2. The bleached uncoated samples had a decrease in breathability of 7.29%, while the unbleached uncoated samples only had a decrease of 1.88%. Without intent to be bound by theory, it is believed that this result demonstrates that clothing made of textile coated according to this disclosure will be comfortable and will breathe like uncoated clothing.

### Breathability—DriFire®

DriFire® textile samples prepared according to Examples 6, 7, and 8 were run through the ASTM E 96 Standard for Water Vapor Transmission of Materials using the water method as described in the standard. Uncoated DriFire® samples were tested as a control. The test method measures the weight of water lost as vapor transmitted through the tested material.

Samples of each type of DriFire® were run in triplicate in a humidity chamber set to 21° C. and 50% relative humidity. Samples were weighed over the course of 2 days, and average differences in breathability from the control were calculated. The PMO-only samples according to Example 6 showed an average of 33.9% loss in breathability. The samples with secondary silane coatings showed increased losses in breathability. Specifically, the PMO+isooctylsilane superhydrophobic material of Example 7 showed a 34.6% loss of breathability, and the omniphobic material of Example 8 showed a 42.0% loss of breathability. For both of these, it is assumed that around 34% of the breathability loss is attributable to the PMO and that additional losses are attributable to the secondary coating. Thus, the secondary silane coatings add only a small loss of breathability to the DriFire® fabric, relative to the PMO coating alone.

### Tensile Strength—Cotton

Cotton test samples were generated with dimensions of 1.5 inches (weft threads) by 9 inches (warp threads). Of these samples, five were left untreated to act as a control group, five were coated with only PMO according to Example 1, and four were coated with both the PMO and the superhydrophobic isooctylsilane according to Example 2. Verifications of the coatings were conducted by measuring the contact angles.

All samples were pulled using an elastic tensile pull method. The starting gage length was set to 4 inches. Results compared across the control group, the PMO-only group, and the superhydrophobic group, showed that mean Standard Load at Break (lbf), mean Peak Local Maximum (Load 10%) (lbf), and the mean Standard Extension at Break (lbf) for each group were within the standard deviations of the respective measurements for the other groups. It is believed that these results indicate that the coating treatments according to Examples 1 and 2 do not change any aspect of the tensile strength of the cotton fabric.

### Weight Gain

Three samples each of bleached cotton and unbleached cotton, plus six DriFire® textile samples were placed in a humidity chamber at 21° C. at 50% relative humidity. The humidity chamber was used to correct for any weight loss or gain samples would experience through changes in humidity, owing to the hygroscopic nature of cellulosic fibers. After approximately an hour to equilibrate, the samples were removed and promptly weighed. These weights were recorded as the as-received baseline.

All sample then were placed in an ethanol bath. The ethanol bath was changed two times over the course of 24 hours, such that the samples had been exposed to three baths after the 24 hours. The samples were dried and placed in the humidity chamber for an hour to equilibrate before being weighed. These weights were considered to be a washed baseline weight. The washed baseline weight was considered necessary, because it was observed that some samples unexpectedly were reporting a weight loss after the PMO coating process, even though material had been added to the sample during the coating process. The weight loss indicated that something had been removed from the fabric samples during the steps of the PMO coating.

The samples were then taken through the PMO coating procedure. Once the samples showed hydrophobic properties after washing out the poloxamer (P123) templating agent, they were placed back in the humidity chamber at the same settings and equilibrated for approximately one hour. Upon removal from the humidity chamber, the samples were weighed to determine the amount of weight added with the PMO coating.

Next, samples were taken through the isooctylsilane coating process to impart superhydrophobicity. Three of the DriFire® samples were coated with a dimethylsilane/monomethylsilane mixture to impart omniphobicity. Again, samples were loaded into the humidity chamber to equilibrate for about an hour, and then promptly weighed.

The bleached and unbleached cotton superhydrophobic samples as well as the superhydrophobic DriFire® showed a total weight gain of less than 5%. The omniphobic DriFire® samples showed a weight gain of approximately 20%. In both types of treatment, the vast majority of the weight gain was due to the secondary coating. The PMO coating imparted less than a 1% gain in weight.

### Color

Samples were examined according to ASTM D244 Standard Practice for Calculation of Color Tolerances and Color Difference from Instrumentally Measured Color Coordinates for color changes upon treatment with PMO or PMO plus secondary silane. PMO treated cotton prepared according to Example 1 and PMO+isooctylsilane treated cotton prepared according to Example 2 were compared to as-received cotton material using the standard method. The PMO sample showed no meaningful difference in coloration (delta E) after treatment. The PMO+isooctylsilane sample showed a slight graying in the color that was not noticeable to the naked eye.

DriFire® samples prepared according to Examples 6-8 were also subjected to the standard effect on coloration test. The PMO sample according to Example 6, the IOS superhydrophobic sample according to Example 7, and the omniphobic sample according to Example 8 all showed increasing darkening of the fabric. The PMO sample measured slightly darker than the control, the superhydrophobic samples were slightly darker than the PMO, and the omniphobic samples were even darker than the superhydrophobic samples. Nevertheless, the darkening of the DriFire® fabrics after treatment was so slight that the shade remained within United States military specification for batch-to-batch variations in color.

### Further Exemplary Aspects

1. A coated article comprising: a substrate; and a periodic mesoporous organosilica layer adhered to a surface of the substrate.

2. The coated article of aspect 1, wherein the substrate comprises a textile, a glass, a metal, a plastic, leather, artificial leather, wood, paper, rubber, or a ceramic.

3. The coated article of aspect 1, wherein the substrate comprises a woven fabric or a nonwoven fabric.

4. The coated article of aspect 1, wherein the substrate comprises a fabric of fibers selected from the group consisting of cotton, flax, wool, silk, nylon, aramid, polyester, polyethylene, polypropylene, rayon, viscose, linen, cellulose, poly(vinyl chloride), polyethylene terephthalate, acetate, and blends or mixtures of any of the foregoing.

5. The coated article of any of aspects 1 to 4, wherein the periodic mesoporous organosilica layer comprises a silica network of polymerized units having a structure (—O)_{1.5}Si-A-Si(O—)_{1.5}, where A is a C₁-C₅₀ alkylene.

6. The coated article of any of aspects 1 to 4, wherein the periodic mesoporous organosilica layer comprises a silica network of polymerized units having a structure (—O)_{1.5}Si-A-Si(O—)_{1.5}, where A is a C₁-C₂₀ alkylene.

7. The coated article of any of aspects 1 to 4, wherein the periodic mesoporous organosilica layer comprises a silica network of polymerized units having a structure (—O)_{1.5}Si-A-Si(O—)_{1.5}, where A is a C₂-C₁₀ alkylene.

8. The coated article of any of aspects 1 to 4, wherein the periodic mesoporous organosilica layer comprises a silica network of polymerized units having a structure (—O)_{1.5}Si-A-Si(O—)_{1.5}, where A is octan-1,8-diyl.

9. The coated article of any of aspects 1 to 8, wherein the periodic mesoporous organosilica layer comprises a plurality of hexagonally packed columns of organosilica covalently attached to the substrate through silicon-oxygen bonds.

10. The coated article of any of aspects 1 to 9, wherein the periodic mesoporous organosilica layer has an average pore size of 2 nm to 50 nm.

11. The coated article of any of aspects 1 to 10, wherein the periodic mesoporous organosilica layer has a thickness of 1 nm to 20 μm.

12. The coated article of any of aspects 1 to 11, further comprising a secondary silane layer covalently attached to the periodic mesoporous organosilica layer.

13. The coated article of aspect 12, wherein the secondary silane layer is covalently attached to the periodic mesoporous organosilica layer through silicon-oxygen bonds.

14. The coated article of aspect 12 or 13, wherein the secondary silane layer comprises a network of polymerized units having a structure (—O)₃Si—R¹, where R¹ is a straight-chained or branched C₁-C₅₀ alkyl.

15. The coated article of aspect 12 or 13, wherein the secondary silane layer comprises a network of polymerized units having a structure (—O)₃Si—R¹, where R¹ is a straight-chained or branched C₁-C₂₀ alkyl.

16. The coated article of aspect 12 or 13, wherein the secondary silane layer comprises a network of polymerized units having a structure (—O)₃Si—R¹, where R¹ is a branched C₂-C₂₀ alkyl.

17. The coated article of aspect 12 or 13, wherein the secondary silane layer comprises a network of polymerized units having a structure (—O)₃Si—R¹, where R¹ is a branched C₂-C₂₀ alkyl comprising a terminal tertiary carbon atom.

18. The coated article of aspect 12 or 13, wherein the secondary silane layer comprises a network of polymerized units having a structure (—O)₃Si—R¹, where R¹ is 2,4,4-trimethylpentyl.

19. The coated article of any of aspects 12 to 18, wherein the combination of the periodic mesoporous organosilica layer and the secondary silane layer renders the surface of the substrate superhydrophobic.

20. The coated article of any of aspects 12 to 19, wherein the combination of the periodic mesoporous organosilica layer and the secondary silane layer renders the surface of the substrate superhydrophobic, whereby the coated article exhibits a water contact angle greater than 150°, measured according to ASTM D7334.

21. The coated article of any of aspects 12 to 20, wherein the secondary silane layer comprises a network of polymerized units chosen from T units, D units, M units, and combinations thereof, where: the T units have a structure (—O)₃Si—R²; the D units have a structure (—O)₂Si(R³)(R⁴); the M units have a structure (—O)Si(R⁵)(R⁶)(R⁷); and R², R³, R⁴, R⁵, R⁶, and R⁷ are independently C₁-C₂₀ alkyl.

22. The coated article of aspect 21, wherein R², R³, R⁴, R⁵, R⁶, and R⁷ are independently C₁-C₅ alkyl.

23. The coated article of aspect 21, wherein R², R³, R⁴, R⁵, R⁶, and R⁷ are identical and are selected from C₁-C₅ alkyl.

24. The coated article of aspect 21, wherein R², R³, R⁴, R⁵, R⁶, and R⁷ are methyl.

25. The coated article of any of aspects 21-24, wherein the network of polymerized units comprises T units and D units, the network of polymerized units having a molar ratio of T units to D units from 1:100 to 100:1.

26. The coated article of any of aspects 21-24, wherein the molar ratio of T units to D units in the network of polymerized units is from 1:1 to 10:1.

27. The coated article of aspect 26, wherein the molar ratio of T units to D units in the network of polymerized units is from 1:1 to 5:1, or about 2:1.

28. The coated article of any of aspects 21-24, wherein the network of polymerized units comprises T units, D units, and M units, the network of polymerized units having a molar ratio of T units to D units from 1:100 to 100:1 and a molar ratio of [T units+D units] to M units from 5:1 to 1000:1, or from 9:1 to 999:1, or from 10:1 to 1000:1, or from 20:1 to 1000:1, or from 100:1 to 1000:1, or from 500:1 to 1000:1.

29. The coated article of any of aspects 21-24, wherein the network of polymerized units comprises T units, D units, and M units, the network of polymerized units having a molar ratio of T units to D units from 1:1 to 5:1, or about 2:1, and a molar ratio of [T units+D units] to M units from 5:1 to 1000:1, or from 9:1 to 999:1, or from 10:1 to 1000:1, or from 20:1 to 1000:1, or from 100:1 to 1000:1, or from 500:1 to 1000:1.

30. The coated article of any of aspects 21-29, wherein the combination of the periodic mesoporous organosilica layer and the secondary silane layer renders the surface of the substrate omniphobic, whereby the coated article exhibits a water contact angle greater than 150° and a corn-oil contact angle greater than 90°, measured according to ASTM D7334.

31. The coated article of any of aspects 12-30, wherein the secondary silane layer has a thickness of 1 nm to 20 μm.

32. A method for coating a surface of a substrate, the method comprising: contacting the surface of the substrate with a coating mixture, the coating mixture comprising: a hydrolyzed organosilane of formula (HO)₃Si-A-Si(OH)₃, where A is a C₁-C₅₀ alkylene; and a templating agent; curing the coating mixture on the surface to allow the hydrolyzed organosilane to polymerize and form a PMO-coated article comprising a periodic mesoporous organosilica layer adhered to the surface of the substrate; and removing residual templating agent from the PMO-coated article after the curing.

33. The method of aspect 32, wherein the templating agent is: surfactants; poloxamers; ionic surfactants such as cetyltrimethyl ammonium bromide (CTAB) and sodium dodecyl sulfate (SDS); nonionic surfactants such as Brij (surfactants of a nominal formula EₘCₙ, where Eₘ is hydrophilic chain of m oxyethylene groups E and Cₙ is a hydrophobic alkyl chain having n carbon atoms); and phosphonated poloxamers; combinations of dibenzoyl-L-tartaric acid, D-maltose, and

D-glucose; combinations of tartaric acid and metal chlorides; long-chain alkoxysilanes; triethanolamine; ethoxylated sorbitan esters; multiwall carbon nanotubes; or cellulose nanocrystals.

34. The method of aspect 32, wherein the templating agent is a surfactant.

35. The method of aspect 32, wherein the templating agent is a poloxamer.

36. The method of aspect 32, wherein the templating agent is a poloxamer of structure HO—(PEO)ₐ(PPO)_{b}(PEO)ₐ-H, where: each PEO is a polyoxyethylene unit; PPO is a polyoxypropylene unit; subscript a is an integer from 2 to 130 and represents a degree of polymerization of blocks of polyoxyethylene units and is the same in both instances; subscript b is from 15 to 100 and represents a degree of polymerization of a block of polyoxypropylene units; and the poloxamer has a total molecular weight of from 1500 g/mol to 15,000 g/mol and a polyoxyethylene content of from 10% by weight to 80% by weight, based on the total weight of the poloxamer.

37. The method of aspect 35, wherein the poloxamer comprises poloxamer 403 of formula HO—(PEO)₂₀(PPO)₇₀(PEO)₂₀—H.

38. The method of any of aspects 32 to 37, wherein the substrate comprises a textile, a glass, a metal, a plastic, leather, artificial leather, wood, paper, rubber, or a ceramic.

39. The method of any of aspects 32 to 37, wherein the substrate comprises a woven fabric or a nonwoven fabric.

40. The method of any of aspects 32 to 37, wherein the substrate comprises a fabric of fibers chosen from cotton, flax, wool, silk, nylon, aramid, polyester, polyethylene, polypropylene, rayon, viscose, linen, cellulose, poly(vinyl chloride), polyethylene terephthalate, acetate, or blends or mixtures of any of the foregoing.

41. The method of any of aspects 32 to 40, wherein A is a C₁-C₂₀ alkylene or a C₂-C₁₀ alkylene.

42. The method of any of aspects 32 to 40, wherein A is octan-1,8-diyl.

43. The method of any of aspects 32 to 42, further comprising mixing a first solution comprising the hydrolyzed organosilane with a second solution comprising the templating agent to prepare the coating mixture.

44. The method of aspect 43, further comprising combining an organosilane with an acidified or basified polar solvent to hydrolyze the organosilane and form the first solution, wherein the organosilane has formula (XO)₃Si-A-Si(OX)₃, where each X is a C₁-C₂₀ alkyl and A is a C₁-C₅₀ alkylene.

45. The method of aspect 43, further comprising combining an organosilane with an acidified or basified polar solvent to hydrolyze the organosilane and form the first solution, wherein the organosilane has formula (XO)₃Si-A-Si(OX)₃, where each X is methyl or ethyl and A is a C₁-C₅₀ alkylene.

46. The method of aspect 43, further comprising combining an organosilane with an acidified or basified polar solvent to hydrolyze the organosilane and form the first solution, wherein the organosilane has formula (XO)₃Si-A-Si(OX)₃, where each X is ethyl and A is a C₁-C₅₀ alkylene.

47. The method of any of aspects 32 to 46, further comprising: contacting the PMO-coated article with a secondary silane coating solution, the secondary silane coating solution comprising at least one hydrolyzed alkylsilane, wherein the at least one hydrolyzed alkylsilane comprises: a hydrolyzed monoalkylsilane of formula (HO)₃SiR¹, where R¹ is a straight-chained or branched C₁-C₅₀ alkyl; or a combination of hydrolyzed alkylsilanes, wherein the combination comprises at least one alkylsilane from any two or all three of groups (a), (b), and (c): (a) a hydrolyzed monoalkylsilane of formula (HO)₃SiR², where R² is a straight-chained or branched C₁-C₂₀ alkyl; (b) a hydrolyzed dialkylsilane of formula (HO)₂SiR³R⁴, where R³ and R⁴ are independently straight-chained or branched C₁-C₂₀ alkyl; (c) a hydrolyzed trialkylsilane of formula (HO)SiR⁵R⁶R⁷, where R⁵, R⁶, and R⁷ are independently straight-chained or branched C₁-C₂₀ alkyl; and curing the secondary silane coating solution on the PMO-coated article to allow the at least one alkylsilane to polymerize and form a dual-coated article comprising a secondary alkylsilane layer attached to the periodic mesoporous organosilica layer on the surface of the substrate.

48. The method of aspect 47, wherein the at least one hydrolyzed alkylsilane is a hydrolyzed monoalkylsilane of formula (HO)₃SiR¹, where R¹ is a branched C₂-C₂₀ alkyl.

49. The method of aspect 47, wherein the at least one hydrolyzed alkylsilane is a hydrolyzed monoalkylsilane of formula (HO)₃SiR¹, where R¹ is a branched C₂-C₂₀ alkyl comprising a terminal tertiary carbon atom.

50. The method of aspect 47, wherein the at least one hydrolyzed alkylsilane is a hydrolyzed monoalkylsilane of formula (HO)₃SiR¹, where R¹ is 2,4,4-trimethylpentyl.

51. The method of any of aspects 32-50, wherein the combination of the periodic mesoporous organosilica layer and the secondary silane layer renders the surface of the substrate superhydrophobic, whereby the coated article exhibits a water contact angle greater than 150°, measured according to ASTM D7334.

52. The method of aspect 47, wherein the at least one hydrolyzed alkylsilane is a combination comprising a hydrolyzed monoalkylsilane of formula (HO)₃SiR² and a hydrolyzed dialkylsilane of formula (HO)₂SiR³R⁴, where R², R³, and R⁴ are independently straight-chained or branched C₁-C₂₀ alkyl.

53. The method of aspect 47, wherein the at least one hydrolyzed alkylsilane is a combination comprising a hydrolyzed monoalkylsilane of formula (HO)₃SiR² and a hydrolyzed dialkylsilane of formula (HO)₂SiR³R⁴, where R², R³, and R⁴ are independently straight-chained or branched C₁-C₅ alkyl.

54. The method of aspect 47, wherein the at least one hydrolyzed alkylsilane is a combination comprising a hydrolyzed monoalkylsilane of formula (HO)₃SiR² and a hydrolyzed dialkylsilane of formula (HO)₂SiR³R⁴, where R², R³, and R⁴ are identical and are selected from C₁-C₅ alkyl.

55. The method of aspect 47, wherein the at least one hydrolyzed alkylsilane is a combination comprising a hydrolyzed monoalkylsilane of formula (HO)₃SiR² and a hydrolyzed dialkylsilane of formula (HO)₂SiR³R⁴, where R², R³, and R⁴ are methyl.

56. The method of aspect 52, wherein a molar ratio of the hydrolyzed monoalkylsilane and the hydrolyzed dialkylsilane in the secondary silane coating solution is from 1:100 to 100:1.

57. The method of aspect 52, wherein a molar ratio of the hydrolyzed monoalkylsilane and the hydrolyzed dialkylsilane in the secondary silane coating solution is from 1:10 to 10:1.

58. The method of aspect 52, wherein a molar ratio of the hydrolyzed monoalkylsilane and the hydrolyzed dialkylsilane in the secondary silane coating solution is from 1:1 to 10:1.

59. The method of aspect 52, wherein a molar ratio of the hydrolyzed monoalkylsilane and the hydrolyzed dialkylsilane in the secondary silane coating solution is from 1:1 to 5:1.

60. The method of aspect 52, wherein a molar ratio of the hydrolyzed monoalkylsilane and the hydrolyzed dialkylsilane in the secondary silane coating solution is about 2:1.

61. The method of aspect 52, wherein the combination further comprises a hydrolyzed trialkylsilane of formula (HO)SiR⁵R⁶R⁷.

62. The method of aspect 47, wherein the at least one hydrolyzed alkylsilane is a combination comprising a hydrolyzed monoalkylsilane of formula (HO)₃SiR² and a hydrolyzed trialkylsilane of formula (HO)SiR⁵R⁶R⁷.

63. The method of aspect 47, wherein the at least one hydrolyzed alkylsilane is a combination comprising a hydrolyzed dialkylsilane of formula (HO)₂SiR³R⁴ and a hydrolyzed trialkylsilane of formula (HO)SiR⁵R⁶R⁷.

64. The method of aspect 61, wherein a molar ratio of [hydrolyzed monoalkylsilane plus hydrolyzed dialkylsilane] to hydrolyzed trialkylsilane in the secondary silane coating solution is from 5:1 to 1000:1, or from 9:1 to 999:1, or from 10:1 to 1000:1, or from 20:1 to 1000:1, or from 100:1 to 1000:1, or from 500:1 to 1000:1.

65. The method of aspect 47, wherein the combination of the periodic mesoporous organosilica layer and the secondary silane layer renders the surface of the substrate omniphobic, whereby the coated article exhibits a water contact angle greater than 150° and a corn-oil contact angle greater than 90°, measured according to ASTM D7334.

66. The method of aspect 47, further comprising: combining at least one alkylalkoxysilane and an acidic solvent to prepare the secondary silane coating solution, wherein the at least one alkylalkoxysilane comprises: a monoalkyltrialkoxysilane of formula (XO)₃SiR¹, where R¹ is a straight-chained or branched C₁-C₅₀ alkyl; or a combination of alkylalkoxysilanes, wherein the combination includes at least one alkylalkoxysilane from any two or all three of groups (a), (b), and (c): (a) a monoalkyltrialkoxysilane of formula (XO)₃SiR², where R² is a straight-chained or branched C₁-C₂₀ alkyl; and (b) a dialkyldialkoxysilane of formula (XO)₂SiR³R⁴, where R³ and R⁴ are independently straight-chained or branched C₁-C₂₀ alkyl; and (c) a trialkylalkoxysilane of formula (XO)SiR⁵R⁶R⁷, where R⁵, R⁶, and R⁷ are independently straight-chained or branched C₁-C₂₀ alkyl, wherein X, in each instance, is a C₁-C₂₀ alkyl.

67. The method of aspect 66, wherein X, in each instance, is methyl or ethyl.

68. The method of aspect 66, wherein X, in each instance, is ethyl.

69. The method of any of aspects 66-68, wherein the acidic solvent comprises a mixture of a polar solvent and a mineral acid.

70. The method of any of aspects 66-68, wherein the acidic solvent comprises hydrochloric acid and ethanol.

71. The method of aspect 47, wherein curing the secondary silane coating solution comprises heating the secondary silane coating solution on the PMO-coated article at from 50° C. to 150° C., optionally 100° C. for 30 minutes.

72. The method of aspect 47, wherein contacting the PMO-coated article with a secondary silane coating solution comprises dipping the PMO-coated article into the secondary silane coating solution and removing the dipped PMO-coated article from the secondary silane coating solution.

73. The method of any of aspects 32 to 72, wherein contacting the surface of the substrate with the coating mixture comprises dipping the substrate into the coating mixture and removing the dipped substrate from the coating mixture.

74. The method of any of aspects 32 to 73, wherein curing the coating mixture comprises heating the coating mixture on the substrate at from 30° C. to 200° C., optionally 100° C.

75. The method of any of aspects 32 to 74, wherein removing residual templating agent comprises washing the PMO-coated article in a polar solvent.

76. The method of any of aspects 32 to 75, wherein removing residual templating agent comprises washing the PMO-coated article in an ethanol bath.

Unless otherwise defined, all technical and scientific terms used herein have the same meaning as commonly understood by one of ordinary skill in the art to which the invention belongs. The terminology used in the description herein is for describing particular aspects only and is not intended to be limiting. As used in the specification and appended claims, the singular forms “a,” “an,” and “the” are intended to include the plural forms as well, unless the context clearly indicates otherwise.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular aspects have been illustrated and described herein, it should be understood that various other changes and modifications may be made without departing from the scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

Patents, publications, and applications mentioned in the specification are indicative of the levels of those skilled in the art to which the invention pertains. These patents, publications, and applications are incorporated herein by reference to the same extent as if each individual patent, publication, or application was specifically and individually incorporated herein by reference.

The foregoing description is illustrative of particular embodiments of the invention, but is not meant to be a limitation upon the practice thereof. The following claims, including all equivalents thereof, are intended to define the scope of the invention.

1. A coated article comprising:
a substrate; and
a periodic mesoporous organosilica layer adhered to a surface of the substrate.

2. The coated article of claim 1, wherein the substrate comprises a textile, a glass, a metal, a plastic, leather, artificial leather, wood, paper, rubber, or a ceramic.

3. The coated article of claim 1, wherein the substrate comprises a woven fabric or a nonwoven fabric.

4. The coated article of claim 1, wherein the substrate comprises a fabric of fibers selected from the group consisting of cotton, flax, wool, silk, nylon, aramid, polyester, polyethylene, polypropylene, rayon, viscose, linen, cellulose, poly(vinyl chloride), polyethylene terephthalate, acetate, and blends or mixtures of any of the foregoing.

5. The coated article of any one of claims 1 to 4, wherein the periodic mesoporous organosilica layer comprises a silica network of polymerized units having a structure (—O)_{1.5}Si-A-Si(O—)_{1.5}, where A is a C₁-C₅₀ alkylene.

6. The coated article of any one of claims 1 to 4, wherein the periodic mesoporous organosilica layer comprises a silica network of polymerized units having a structure (—O)_{1.5}Si-A-Si(O—)_{1.5}, where A is a C₁-C₂₀ alkylene.

7. The coated article of any one of claims 1 to 4, wherein the periodic mesoporous organosilica layer comprises a silica network of polymerized units having a structure (—O)_{1.5}Si-A-Si(O—)_{1.5}, where A is a C₂-C₁₀ alkylene.

8. The coated article of any one of claims 1 to 4, wherein the periodic mesoporous organosilica layer comprises a silica network of polymerized units having a structure (—O)_{1.5}Si-A-Si(O—)_{1.5}, where A is octan-1,8-diyl.

9. The coated article of any one of claims 1 to 4, wherein the periodic mesoporous organosilica layer comprises a plurality of hexagonally packed columns of organosilica covalently attached to the substrate through silicon-oxygen bonds.

10. The coated article of any one of claims 1 to 4, wherein the periodic mesoporous organosilica layer has an average pore size of 2 nm to 50 nm.

11. The coated article of any one of claims 1 to 4, wherein the periodic mesoporous organosilica layer has a thickness of 1 nm to 20 μm.

12. The coated article of any one of claims 1 to 4, further comprising a secondary silane layer covalently attached to the periodic mesoporous organosilica layer.

13. The coated article of claim 12, wherein the secondary silane layer is covalently attached to the periodic mesoporous organosilica layer through silicon-oxygen bonds.

14. The coated article of claim 12, wherein the secondary silane layer comprises a network of polymerized units having a structure (—O)₃Si—R¹, where R¹ is a straight-chained or branched C₁-C₅₀ alkyl.

15. The coated article of claim 12, wherein the secondary silane layer comprises a network of polymerized units having a structure (—O)₃Si—R¹, where R¹ is a straight-chained or branched C₁-C₂₀ alkyl.

16. The coated article of claim 12, wherein the secondary silane layer comprises a network of polymerized units having a structure (—O)₃Si—R¹, where R¹ is a branched C₂-C₂₀ alkyl.

17. The coated article of claim 12, wherein the secondary silane layer comprises a network of polymerized units having a structure (—O)₃Si—R¹, where R¹ is a branched C₂-C₂₀ alkyl comprising a terminal tertiary carbon atom.

18. The coated article of claim 12, wherein the secondary silane layer comprises a network of polymerized units having a structure (—O)₃Si—R¹, where R¹ is 2,4,4-trimethylpentyl.

19. The coated article of claim 12, wherein the combination of the periodic mesoporous organosilica layer and the secondary silane layer renders the surface of the substrate superhydrophobic.

20. The coated article of claim 12, wherein the combination of the periodic mesoporous organosilica layer and the secondary silane layer renders the surface of the substrate superhydrophobic, whereby the coated article exhibits a water contact angle greater than 150°, measured according to ASTM D7334.

21. The coated article of claim 12, wherein the secondary silane layer comprises a network of polymerized units chosen from T units, D units, M units, and combinations thereof, where:
the T units have a structure (—O)₃Si—R²;
the D units have a structure (—O)₂Si(R³)(R⁴);
the M units have a structure (—O)Si(R⁵)(R⁶)(R⁷); and
R², R³, R⁴, R⁵, R⁶, and R⁷ are independently C₁-C₂₀ alkyl.

22. The coated article of claim 21, wherein R², R³, R⁴, R⁵, R⁶, and R⁷ are independently C₁-C₅ alkyl.

23. The coated article of claim 21, wherein R², R³, R⁴, R⁵, R⁶, and R⁷ are identical and are selected from C₁-C₅ alkyl.

24. The coated article of claim 21, wherein R², R³, R⁴, R⁵, R⁶, and R⁷ are methyl.

25. The coated article of claim 21, wherein the network of polymerized units comprises T units and D units, the network of polymerized units having a molar ratio of T units to D units from 1:100 to 100:1.

26. The coated article of claim 21, wherein the molar ratio of T units to D units in the network of polymerized units is from 1:1 to 10:1.

27. The coated article of claim 21, wherein the molar ratio of T units to D units in the network of polymerized units is from 1:1 to 5:1, or about 2:1.

28. The coated article of claim 21, wherein the network of polymerized units comprises T units, D units, and M units, the network of polymerized units having a molar ratio of T units to D units from 1:100 to 100:1 and a molar ratio of [T units+D units] to M units from 5:1 to 1000:1, or from 9:1 to 999:1, or from 10:1 to 1000:1, or from 20:1 to 1000:1, or from 100:1 to 1000:1, or from 500:1 to 1000:1.

29. The coated article of claim 21, wherein the network of polymerized units comprises T units, D units, and M units, the network of polymerized units having a molar ratio of T units to D units from 1:1 to 5:1, or about 2:1, and a molar ratio of [T units+D units] to M units from 5:1 to 1000:1, or from 9:1 to 999:1, or from 10:1 to 1000:1, or from 20:1 to 1000:1, or from 100:1 to 1000:1, or from 500:1 to 1000:1.

30. The coated article of claim 21, wherein the combination of the periodic mesoporous organosilica layer and the secondary silane layer renders the surface of the substrate omniphobic, whereby the coated article exhibits a water contact angle greater than 150° and a corn-oil contact angle greater than 90°, measured according to ASTM D7334.

31. The coated article of claim 12, wherein the secondary silane layer has a thickness of 1 nm to 20 μm.

32. A method for coating a surface of a substrate, the method comprising:
contacting the surface of the substrate with a coating mixture, the coating mixture comprising:
a hydrolyzed organosilane of formula (HO)₃Si-A-Si(OH)₃, where A is a C₁-C₅₀ alkylene; and
a templating agent;
curing the coating mixture on the surface to allow the hydrolyzed organosilane to polymerize and form a PMO-coated article comprising a periodic mesoporous organosilica layer adhered to the surface of the substrate; and
removing residual templating agent from the PMO-coated article after the curing.

33. The method of claim 32, wherein the templating agent is chosen from: surfactants; poloxamers; ionic surfactants such as cetyltrimethyl ammonium bromide (CTAB) and sodium dodecyl sulfate (SDS); nonionic surfactants such as Brij (surfactants of a nominal formula EₘCₙ, where Eₘ is hydrophilic chain of m oxyethylene groups E and Cₙ is a hydrophobic alkyl chain having n carbon atoms); and phosphonated poloxamers; combinations of dibenzoyl-L-tartaric acid, D-maltose, and D-glucose; combinations of tartaric acid and metal chlorides; long-chain alkoxysilanes; triethanolamine; ethoxylated sorbitan esters; multiwall carbon nanotubes; and
cellulose nanocrystals.

34. The method of claim 32, wherein the templating agent is a surfactant.

35. The method of claim 32, wherein the templating agent is a poloxamer.

36. The method of claim 32, wherein the templating agent is a poloxamer of structure HO—(PEO)ₐ(PPO)_{b}(PEO)ₐ—H, where:
each PEO is a polyoxyethylene unit;
PPO is a polyoxypropylene unit;
subscript a is an integer from 2 to 130 and represents a degree of polymerization of blocks of polyoxyethylene units and is the same in both instances;
subscript b is from 15 to 100 and represents a degree of polymerization of a block of polyoxypropylene units; and
the poloxamer has a total molecular weight of from 1500 g/mol to 15,000 g/mol and a polyoxyethylene content of from 10% by weight to 80% by weight, based on the total weight of the poloxamer.

37. The method of claim 35, wherein the poloxamer comprises poloxamer 403 of formula HO-(PEO)₂₀(PPO)₇₀(PEO)₂₀-H.

38. The method of any one of claims 32 to 37, wherein the substrate comprises a textile, a glass, a metal, a plastic, leather, artificial leather, wood, paper, rubber, or a ceramic.

39. The method of any one of claims 32 to 37, wherein the substrate comprises a woven fabric or a nonwoven fabric.

40. The method of any one of claims 32 to 37, wherein the substrate comprises a fabric of fibers chosen from cotton, flax, wool, silk, nylon, aramid, polyester, polyethylene, polypropylene, rayon, viscose, linen, cellulose, poly(vinyl chloride), polyethylene terephthalate, acetate, or blends or mixtures of any of the foregoing.

41. The method of any one of claims 32 to 37, wherein A is a C₁-C₂₀ alkylene or a C₂-C₁₀ alkylene.

42. The method of any one of claims 32 to 37, wherein A is octan-1,8-diyl.

43. The method of any one of claims 32 to 37, further comprising mixing a first solution comprising the hydrolyzed organosilane with a second solution comprising the templating agent to prepare the coating mixture.

44. The method of claim 43, further comprising combining an organosilane with an acidified or basified polar solvent to hydrolyze the organosilane and form the first solution, wherein the organosilane has formula (XO)₃Si-A-Si(OX)₃, where each X is a C₁-C₂₀ alkyl and A is a C₁-C₅₀ alkylene.

45. The method of claim 43, further comprising combining an organosilane with an acidified or basified polar solvent to hydrolyze the organosilane and form the first solution, wherein the organosilane has formula (XO)₃Si-A-Si(OX)₃, where each X is methyl or ethyl and A is a C₁-C₅₀ alkylene.

46. The method of claim 43, further comprising combining an organosilane with an acidified or basified polar solvent to hydrolyze the organosilane and form the first solution, wherein the organosilane has formula (XO)₃Si-A-Si(OX)₃, where each X is ethyl and A is a C₁-C₅₀ alkylene.

47. The method of any one of claims 32 to 37, further comprising:
contacting the PMO-coated article with a secondary silane coating solution, the secondary silane coating solution comprising at least one hydrolyzed alkylsilane,
wherein the at least one hydrolyzed alkylsilane comprises:
a hydrolyzed monoalkylsilane of formula (HO)₃SiR¹, where R¹ is a straight-chained or branched C₁-C₅₀ alkyl; or
a combination of hydrolyzed alkylsilanes, wherein the combination comprises at least one alkylsilane from any two or all three of groups (a), (b), and (c):
(a) a hydrolyzed monoalkylsilane of formula (HO)₃SiR², where R² is a straight-chained or branched C₁-C₂₀ alkyl;
(b) a hydrolyzed dialkylsilane of formula (HO)₂SiR³R⁴, where R³ and R⁴ are independently straight-chained or branched C₁-C₂₀ alkyl;
(c) a hydrolyzed trialkylsilane of formula (HO)SiR⁵R⁶R⁷, where R⁵, R⁶, and R⁷ are independently straight-chained or branched C₁-C₂₀ alkyl; and
curing the secondary silane coating solution on the PMO-coated article to allow the at least one alkylsilane to polymerize and form a dual-coated article comprising a secondary alkylsilane layer attached to the periodic mesoporous organosilica layer on the surface of the substrate.

48. The method of claim 47, wherein the at least one hydrolyzed alkylsilane is a hydrolyzed monoalkylsilane of formula (HO)₃SiR¹, where R¹ is a branched C₂-C₂₀ alkyl.

49. The method of claim 47, wherein the at least one hydrolyzed alkylsilane is a hydrolyzed monoalkylsilane of formula (HO)₃SiR¹, where R¹ is a branched C₂-C₂₀ alkyl comprising a terminal tertiary carbon atom.

50. The method of claim 47, wherein the at least one hydrolyzed alkylsilane is a hydrolyzed monoalkylsilane of formula (HO)₃SiR¹, where R¹ is 2,4,4-trimethylpentyl.

51. The method of claim 47, wherein the combination of the periodic mesoporous organosilica layer and the secondary silane layer renders the surface of the substrate superhydrophobic, whereby the coated article exhibits a water contact angle greater than 150°, measured according to ASTM D7334.

52. The method of claim 47, wherein the at least one hydrolyzed alkylsilane is a combination comprising a hydrolyzed monoalkylsilane of formula (HO)₃SiR² and a hydrolyzed dialkylsilane of formula (HO)₂SiR³R⁴, where R², R³, and R⁴ are independently straight-chained or branched C₁-C₂₀ alkyl.

53. The method of claim 47, wherein the at least one hydrolyzed alkylsilane is a combination comprising a hydrolyzed monoalkylsilane of formula (HO)₃SiR² and a hydrolyzed dialkylsilane of formula (HO)₂SiR³R⁴, where R², R³, and R⁴ are independently straight-chained or branched C₁-C₅ alkyl.

54. The method of claim 47, wherein the at least one hydrolyzed alkylsilane is a combination comprising a hydrolyzed monoalkylsilane of formula (HO)₃SiR² and a hydrolyzed dialkylsilane of formula (HO)₂SiR³R⁴, where R², R³, and R⁴ are identical and are selected from C₁-C₅ alkyl.

55. The method of claim 47, wherein the at least one hydrolyzed alkylsilane is a combination comprising a hydrolyzed monoalkylsilane of formula (HO)₃SiR² and a hydrolyzed dialkylsilane of formula (HO)₂SiR³R⁴, where R², R³, and R⁴ are methyl.

56. The method of claim 52, wherein a molar ratio of the hydrolyzed monoalkylsilane and the hydrolyzed dialkylsilane in the secondary silane coating solution is from 1:100 to 100:1.

57. The method of claim 52, wherein a molar ratio of the hydrolyzed monoalkylsilane and the hydrolyzed dialkylsilane in the secondary silane coating solution is from 1:10 to 10:1.

58. The method of claim 52, wherein a molar ratio of the hydrolyzed monoalkylsilane and the hydrolyzed dialkylsilane in the secondary silane coating solution is from 1:1 to 10:1.

59. The method of claim 52, wherein a molar ratio of the hydrolyzed monoalkylsilane and the hydrolyzed dialkylsilane in the secondary silane coating solution is from 1:1 to 5:1.

60. The method of claim 52, wherein a molar ratio of the hydrolyzed monoalkylsilane and the hydrolyzed dialkylsilane in the secondary silane coating solution is about 2:1.

61. The method of claim 52, wherein the combination further comprises a hydrolyzed trialkylsilane of formula (HO)SiR⁵R⁶R⁷.

62. The method of claim 47, wherein the at least one hydrolyzed alkylsilane is a combination comprising a hydrolyzed monoalkylsilane of formula (HO)₃SiR² and a hydrolyzed trialkylsilane of formula (HO)SiR⁵R⁶R⁷.

63. The method of claim 47, wherein the at least one hydrolyzed alkylsilane is a combination comprising a hydrolyzed dialkylsilane of formula (HO)₂SiR³R⁴ and a hydrolyzed trialkylsilane of formula (HO)SiR⁵R⁶R⁷.

64. The method of claim 61, wherein a molar ratio of [hydrolyzed monoalkylsilane plus hydrolyzed dialkylsilane] to hydrolyzed trialkylsilane in the secondary silane coating solution is from 5:1 to 1000:1, or from 9:1 to 999:1, or from 10:1 to 1000:1, or from 20:1 to 1000:1, or from 100:1 to 1000:1, or from 500:1 to 1000:1.

65. The method of claim 47, wherein the combination of the periodic mesoporous organosilica layer and the secondary silane layer renders the surface of the substrate omniphobic, whereby the coated article exhibits a water contact angle greater than 150° and a corn-oil contact angle greater than 90°, measured according to ASTM D7334.

66. The method of claim 47, further comprising:
combining at least one alkylalkoxysilane and an acidic solvent to prepare the secondary silane coating solution, wherein the at least one alkylalkoxysilane comprises:
a monoalkyltrialkoxysilane of formula (XO)₃SiR¹, where R¹ is a straight-chained or branched C₁-C₅₀ alkyl; or
a combination of alkylalkoxysilanes, wherein the combination includes at least one alkylalkoxysilane from any two or all three of groups (a), (b), and (c):
(a) a monoalkyltrialkoxysilane of formula (XO)₃SiR², where R² is a straight-chained or branched C₁-C₂₀ alkyl; and
(b) a dialkyldialkoxysilane of formula (XO)₂SiR³R⁴, where R³ and R⁴ are independently straight-chained or branched C₁-C₂₀ alkyl; and
(c) a trialkylalkoxysilane of formula (XO)SiR⁵R⁶R⁷, where R⁵, R⁶, and R⁷ are independently straight-chained or branched C₁-C₂₀ alkyl,
wherein X, in each instance, is a C₁-C₂₀ alkyl.

67. The method of claim 66, wherein X, in each instance, is methyl or ethyl.

68. The method of claim 66, wherein X, in each instance, is ethyl.

69. The method of claim 66, wherein the acidic solvent comprises a mixture of a polar solvent and a mineral acid.

70. The method of claim 66, wherein the acidic solvent comprises hydrochloric acid and ethanol.

71. The method of claim 47, wherein curing the secondary silane coating solution comprises heating the secondary silane coating solution on the PMO-coated article at from 50° C. to 150° C., optionally 100° C. for 30 minutes.

72. The method of claim 47, wherein contacting the PMO-coated article with a secondary silane coating solution comprises dipping the PMO-coated article into the secondary silane coating solution and removing the dipped PMO-coated article from the secondary silane coating solution.

73. The method of any one of claims 32 to 37, wherein contacting the surface of the substrate with the coating mixture comprises dipping the substrate into the coating mixture and removing the dipped substrate from the coating mixture.

74. The method of any one of claims 32 to 37, wherein curing the coating mixture comprises heating the coating mixture on the substrate at from 30° C. to 200° C., optionally 100° C.

75. The method of any one of claims 32 to 37, wherein removing residual templating agent comprises washing the PMO-coated article in a polar solvent.

76. The method of any one of claims 32 to 37, wherein removing residual templating agent comprises washing the PMO-coated article in an ethanol bath.
